(19) United States
(12) Patent Application Publication
(10) Pub. No.: US 2019/0317335 A1
(43) Pub. Date: Oct. 17, 2019

(54) IMAGE FORMING OPTICAL SYSTEM AND IMAGE PICKUP APPARATUS USING THE SAME

(71) Applicant: OLYMPUS CORPORATION, Tokyo (JP)

(72) Inventor: Kazuteru KAWAMURA, Tokyo (JP)

(73) Assignee: OLYMPUS CORPORATION, Tokyo (JP)

(21) Appl. No.: 16/375,548

(22) Filed: Apr. 4, 2019

(30) Foreign Application Priority Data
Apr. 17, 2018 (JP) 2018-078962

(51) Int. Cl. G02B 27/64; G02B 7/10; G02B 15/173; G03B 5/00

(52) U.S. Cl. CPC G02B 27/646; G02B 7/10; G03B 2205/0015; G03B 5/00; G02B 15/173

(57) ABSTRACT

An image forming optical system includes a first lens unit having a positive refractive power, a second lens unit having a negative refractive power, a third lens unit having a positive refractive power, a fourth lens unit having a negative refractive power, and a rear-side lens unit which is disposed nearest to an image. The rear-side lens unit includes a positive lens and a negative lens. The first lens unit and the third lens unit do not move in an optical axis direction. At a time of focusing, the fourth lens unit moves toward the image side. The third lens unit includes a positive lens and a negative lens. A motion blur correction lens unit is disposed in the third lens unit, and the following conditional expressions (1) and (2) are satisfied:

0.59≤|fMF/fMB|≤3.0 (1)

70.0≤νdFFp (2).

### CROSS-REFERENCE TO RELATED APPLICATION

The present application is based upon and claims the benefit of priority from the prior Japanese Patent Application No. 2018-078962 filed on Apr. 17, 2018; the entire contents of which are incorporated herein by reference.

### BACKGROUND OF THE INVENTION

### Field of the Invention

The present invention relates to an image forming optical system and an image pickup apparatus using the same.

### Description of the Related Art

There is a large number of scenes in which the photography has to be carried out in an extremely short time. Scenes in which a position of an object varies, dark scenes, and scenes in which a position of an object is not fixed, are examples of such scenes. In a telephoto lens and a super telephoto lens (hereinafter, referred to as ‘telephoto lens’), an angle of view becomes narrow. Therefore, in a case of capturing such scenes by a telephoto lens, situations in which a camera has to be moved occur particularly largely.

In a telephoto lens, both an overall length and a diameter of an optical system are susceptible to become large. As a result, a weight of an optical system also increases. Consequently, in a camera equipped with a telephoto lens, a camera is moved in few cases, and generally, a tripod is used. For such reasons, mobility is degraded in a camera equipped with a telephoto lens. As a result, in scenes such as the abovementioned scenes, an opportunity of photography is missed in many cases. Here, the mobility refers to an ease of carrying, a stability at the time of hand-held photography, and a rapidity of a focusing speed.

In a case of not using a tripod, the hand-held photography is carried out. Since the mobility is improved when the hand-held photography is carried out, tracking an object is improved. However, since there is a large effect of motion blur, a possibility of an object blur becomes high. In addition, since an optical system becomes large and heavy, it is difficult to hold a camera stably. Therefore, it is difficult to acquire a sharp image.

In Japanese Patent Publication No. 5142823 (first example), a taking lens (first example) includes in order from an object side, a first lens unit having a positive refractive power, a second lens unit having a negative refractive power, a third lens unit having a positive refractive power, a fourth lens unit having a positive refractive power, and a fifth lens unit having a negative refractive power. At a time of focusing, the second lens unit and the fourth lens unit move.

In Japanese Patent Application Laid-open Publication No. 2006-171432 (first example), a taking lens (first example) includes in order from an object side, a first lens unit having a positive refractive power, a second lens unit having a negative refractive power, a third lens unit having a positive refractive power, and a fourth lens unit having a negative refractive power. At a time of focusing, the second lens unit and the third lens unit move.

In Japanese Patent Application Laid-open Publication No. 2013-167749 (first example), a zoom lens (first example) includes in order from an object side, a first lens unit having a positive refractive power, a second lens unit having a negative refractive power, a third lens unit having a positive refractive power, and a fourth lens unit having a positive refractive power. At a time of zooming, the second lens unit and the third lens unit move. At a time of focusing, the third lens unit moves.

In Japanese Patent Application Laid-open Publication No. 2017-120382 (first example), a zoom lens (first example) includes in order from an object side, a first lens unit having a positive refractive power, a second lens unit having a negative refractive power, a third lens unit having a positive refractive power, a fourth lens unit having a negative refractive power, and a fifth lens unit having a negative refractive power. At a time of zooming, the first lens unit, the third lens unit, the fourth lens unit, and the fifth lens unit move.

### SUMMARY OF THE INVENTION

An image forming optical system according to at least some embodiments of the present invention comprises in order from an object side:

a first lens unit having a positive refractive power,

a second lens unit having a negative refractive power,

a third lens unit having a positive refractive power,

a fourth lens unit having a negative refractive power, and

a rear-side lens unit which is disposed nearest to an image, wherein

at a time of focusing or at a time of zooming, a distance between the first lens unit and the second lens unit widens,

the rear-side lens unit includes a positive lens and a negative lens,

the first lens unit and the third lens unit, at all the times, do not move in an optical axis direction,

at a time of focusing from an object at a long distance to an object at a close distance, the fourth lens unit moves toward an image side,

the third lens unit includes a positive lens and a negative lens,

a motion blur correction lens unit is disposed in the third lens unit,

a motion blur is corrected by the motion blur correction lens unit being moved in a direction perpendicular to an optical axis, and

the following conditional expressions (1) and (2) are satisfied:

0.59≤|fMF/fMB|≤3.0 (1)

70.0≤νdFFp (2)

where,

fMF denotes a focal length of the third lens unit,

fMB denotes a focal length of the fourth lens unit, and

νdFFp denotes Abbe's number which is the maximum among Abbe's numbers for positive lenses in the first lens unit.

Moreover, another image forming optical system according to at least some other embodiments of the present invention comprises in order from an object side:

a first lens unit having a positive refractive power,

a second lens unit having a negative refractive power,

a third lens unit having a positive refractive power,

a fourth lens unit having a negative refractive power, and

a rear-side lens unit which is disposed nearest to an image, wherein

at a time focusing or at a time of zooming, a distance between the first lens unit and the second lens unit widens,

the rear-side lens unit includes a positive lens and a negative lens,

the first lens unit and the third lens unit, at all the times, do not move in an optical axis direction,

at a time of focusing from an object at a long distance to an object at a close distance, the fourth lens unit moves toward an image side,

the third lens unit includes a positive lens and a negative lens,

a motion blur correction lens unit is disposed in the third lens unit,

a motion blur is corrected by the motion blur correction lens unit being moved in a direction perpendicular to an optical axis, and

the following conditional expressions (2) and (3) are satisfied:

70.0≤νdFFp (2)

3.7≤LTL/fMF≤8.5 (3)

where,

fMF denotes a focal length of the third lens unit,

LTL denotes a distance from a lens surface nearest to an object up to an image plane, and

νdFFp denotes Abbe's number which is the maximum among Abbe's numbers for positive lenses in the first lens unit.

Still another image forming optical system according to at least some other embodiments of the present invention comprises in order from an object side:

a first lens unit having a positive refractive power,

a second lens unit having a negative refractive power,

a third lens unit having a positive refractive power,

a fourth lens unit having a negative refractive power, and

a rear-side lens unit which is disposed nearest to an image, wherein

at a time of focusing or at a time of zooming, a distance between the first lens unit and the second lens unit widens,

the rear-side lens unit includes a positive lens and a negative lens,

the first lens unit and the third lens unit, at all the times, do not move in an optical axis direction,

at a time of focusing from an object at a long distance to an object at a close distance, the fourth lens unit moves toward an image side,

the third lens unit includes a positive lens and a negative lens,

a motion blur correction lens unit is disposed in the third lens unit,

a motion blur is corrected by the motion blur correction lens unit being moved in a direction perpendicular to an optical axis,

the motion blur correction lens unit includes a positive lens and a negative lens, and

the following conditional expressions (4) and (5) are satisfied:

1.5≤|LTL/fFB|≤9.5 (4)

−2.5≤fMB/fR≤−0.15 (5)

where,

fFB denotes a focal length of the second lens unit,

LTL denotes a distance from a lens surface nearest to an object up to an image plane,

fMB denotes a focal length of the fourth lens unit, and

fR denotes a focal length of the rear-side lens unit.

Moreover, still another image forming optical system according to at least some other embodiments of the present invention comprises in order from an object side:

a first lens unit having a positive refractive power,

a second lens unit having a negative refractive power,

a third lens unit having a positive refractive power,

a fourth lens unit having a negative refractive power, and

a rear-side lens unit which is disposed nearest to an image, wherein

at a time of focusing or at a time of zooming, a distance between the first lens unit and the second lens unit widens,

the rear-side lens unit includes a positive lens and a negative lens,

the first lens unit and the third lens unit, at all the times, do not move in an optical axis direction,

at a time of focusing from an object at a long distance to an object at a close distance, the fourth lens unit moves toward an image side,

the third lens unit includes a positive lens and a negative lens,

a motion blur correction lens unit is disposed in the third lens unit,

a motion blur is corrected by the motion blur correction lens unit being moved in a direction perpendicular to an optical axis,

the third lens unit includes in order from the object side, an object-side sub unit and an image-side sub unit,

the object-side sub unit includes a positive lens and a negative lens,

the image-side sub unit includes the motion blur correction lens unit, and

the motion blur correction lens unit includes a positive lens and a negative lens.

Moreover, an image pickup apparatus of the present invention comprises:

an optical system, and

an image pickup element which has an image pickup surface, and which converts an image formed on the image pickup surface by the optical system to an electric signal, wherein

the optical system is one of the abovementioned image forming optical systems.

### BRIEF DESCRIPTION OF THE DRAWINGS

FIG. 1A, FIG. 1B, and FIG. 1C are lens cross-sectional views of a macro lens of an example 1;

FIG. 2A, FIG. 2B, and FIG. 2C are lens cross-sectional views of a macro lens of an example 2;

FIG. 3A, FIG. 3B, and FIG. 3C are lens cross-sectional views of a macro lens of an example 3;

FIG. 4A, FIG. 4B, and FIG. 4C are lens cross-sectional views of a macro lens of an example 4;

FIG. 5A, FIG. 5B, and FIG. 5C are lens cross-sectional views of a zoom optical system of an example 5;

FIG. 6A, FIG. 6B, and FIG. 6C are lens cross-sectional views of a zoom optical system of an example 6;

FIG. 7A, FIG. 7B, and FIG. 7C are lens cross-sectional views of a zoom optical system of an example 7;

FIG. 8A, FIG. 8B, and FIG. 8C are lens cross-sectional views of a zoom optical system of an example 8;

FIG. 9A, FIG. 9B, and FIG. 9C are lens cross-sectional views of a zoom optical system of an example 9;

FIG. 10A, FIG. 10B, FIG. 10C, FIG. 10D, FIG. 10E, FIG. 10F, FIG. 10G, FIG. 10H, FIG. 10I, FIG. 10J, FIG. 10K, and FIG. 10L are aberration diagrams of the macro lens of the example 1;

FIG. 11A, FIG. 11B, FIG. 11C, FIG. 11D, FIG. 11E, FIG. 11F, FIG. 11G, FIG. 11H, FIG. 11I, FIG. 11J, FIG. 11K, and FIG. 11L are aberration diagrams of the macro lens of the example 2;

FIG. 12A, FIG. 12B, FIG. 12C, FIG. 12D, FIG. 12E, FIG. 12F, FIG. 12G, FIG. 12H, FIG. 12I, FIG. 12J, FIG. 12K, and FIG. 12L are aberration diagrams of the macro lens of the example 3;

FIG. 13A, FIG. 13B, FIG. 13C, FIG. 13D, FIG. 13E, FIG. 13F, FIG. 13G, FIG. 13H, FIG. 13I, FIG. 13J, FIG. 13K, and FIG. 13L are aberration diagrams of the macro lens of the example 4;

FIG. 14A, FIG. 14B, FIG. 14C, FIG. 14D, FIG. 14E, FIG. 14F, FIG. 14G, FIG. 14H, FIG. 14I, FIG. 14J, FIG. 14K, and FIG. 14L are aberration diagrams of the zoom optical system of the example 5;

FIG. 15A, FIG. 15B, FIG. 15C, FIG. 15D, FIG. 15E, FIG. 15F, FIG. 15G, FIG. 15H, FIG. 15I, FIG. 15J, FIG. 15K, and FIG. 15L are aberration diagrams of the zoom optical system of the example 6;

FIG. 16A, FIG. 16B, FIG. 16C, FIG. 16D, FIG. 16E, FIG. 16F, FIG. 16G, FIG. 16H, FIG. 16I, FIG. 16J, FIG. 16K, and FIG. 16L are aberration diagrams of the zoom optical system of the example 7;

FIG. 17A, FIG. 17B, FIG. 17C, FIG. 17D, FIG. 17E, FIG. 17F, FIG. 17G, FIG. 17H, FIG. 17I, FIG. 17J, FIG. 17K, and FIG. 17L are aberration diagrams of the zoom optical system of the example 8;

FIG. 18A, FIG. 18B, FIG. 18C, FIG. 18D, FIG. 18E, FIG. 18F, FIG. 18G, FIG. 18H, FIG. 18I, FIG. 18J, FIG. 18K, and FIG. 18L are aberration diagrams of the zoom optical system of the example 9;

FIG. 19 is a cross-sectional view of an image pickup apparatus;

FIG. 20 is a front perspective view of the image pickup apparatus;

FIG. 21 is a rear cross-sectional view of the image pickup apparatus; and

FIG. 22 is a structural block diagram of an internal circuit of main components of the image pickup apparatus.

### DETAILED DESCRIPTION OF THE INVENTION

Prior to the explanation of examples, action and effect of embodiments according to certain aspects of the present invention will be described below. In the explanation of the action and effect of the embodiments concretely, the explanation will be made by citing concrete examples. However, similar to a case of the examples to be described later, aspects exemplified thereof are only some of the aspects included in the present invention, and there exists a large number of variations in these aspects. Consequently, the present invention is not restricted to the aspects that will be exemplified.

Basic arrangement of an image forming optical system of a first embodiment to an image forming optical system of a fourth embodiment (hereinafter, referred to as ‘image forming optical system of the present embodiment’) will be described below.

The basic arrangement of the image forming optical system of the present embodiment has in order from an object side, a first lens unit having a positive refractive power, a second lens unit having a negative refractive power, a third lens unit having a positive refractive power, a fourth lens unit having a negative refractive power, and a rear-side lens unit which is disposed nearest to an image, and at a time of focusing or at a time of zooming, a distance between the first lens unit and the second lens unit widens, the rear-side lens unit includes a positive lens and a negative lens, the first lens unit and the third lens unit, at all the times, do not move in an optical axis direction, at a time of focusing from an object at a long distance to an object at a close distance, the fourth lens unit moves toward an image side, the third lens unit includes a positive lens and a negative lens, a motion blur correction lens unit is disposed in the third lens unit, and a motion blur is corrected by the motion blur correction lens unit being moved in a direction perpendicular to an optical axis.

The basic arrangement of the image forming optical system of the present embodiment has the first lens unit having a positive refractive power, the second lens unit having a negative refractive power, the third lens unit having a positive refractive power, the fourth lens unit having a negative refractive power, and the rear-side lens unit which is disposed nearest to the image, and the rear-side lens unit includes the positive lens and the negative lens.

In this case, with reference to the third lens unit, a lens unit having a negative refractive power and a lens unit including a positive refractive power are disposed on the object side of the third lens unit and the image side of the third lens unit respectively. Therefore, in the basic arrangement, an optical system in which an arrangement of the refractive power is symmetric, is formed. Accordingly, it is possible to correct favorably an off-axis aberration such as a distortion or a chromatic aberration of magnification, while facilitating shortening of an overall length of the optical system.

By varying the distance between the first lens unit and the second lens unit at the time of focusing or at the time of zooming, it is possible to change largely a focal length of a combined optical system formed by the first lens unit and the second lens unit. Consequently, it is possible to use a large variation in the focal length of the combined optical system for focusing to an object at a close distance or for zooming to a further telephoto side.

In the basic arrangement, it becomes easy to make becoming large the negative refractive power of the second lens unit and the negative refractive power of the fourth lens unit simultaneously. By the refractive power of the second lens unit large, a telephoto effect is enhanced. As a result, it becomes easy to shorten the overall length of the optical system. Moreover, it becomes easy to make a diameter of the second lens unit small.

By the refractive power of the fourth lens unit becoming large, it becomes easy to increase an amount of movement of an image plane with respect to a movement of the fourth lens unit in the optical axis direction. By letting the fourth lens unit to be a focusing lens unit, focusing to an object positioned at even closer distance becomes possible. Moreover, by the negative refractive power of the fourth lens unit becoming large, it becomes easy to make a diameter of the fourth lens unit small. In this case, since the fourth lens unit is made light-weight, it is possible to carry out quick focusing.

The first lens unit is heavy and is farthest from the image plane. When the first lens unit moves both at the time of focusing and at the time of zooming, a center of gravity of the optical system varies largely.

Therefore, the first lens unit is to be fixed in the optical axis direction. Accordingly, it is possible to reduce a fluctuation in a position of the center of gravity of the optical system both at the time of focusing and at the time of zooming. As a result, it is possible to secure stability at the time of photography. A photographing state varies widely due to focusing and zooming. By fixing the first lens unit in the optical axis direction, it is possible to secure stability in all photographing states.

Moreover, the third lens unit is fixed both at the time of focusing and at the time of zooming. Accordingly, in a case in which the motion blur correction lens unit is disposed in the third lens unit, a motion blur correction control with even higher accuracy becomes possible.

It is desirable that the motion blur correction lens unit has a small diameter. Moreover, it is desirable that the motion blur correction sensitivity is high. When the motion blur correction sensitivity is high, it is possible to correct the motion blur with a small amount of movement. As a result, small-sizing of a drive unit and a quick correction become possible. The motion blur correction sensitivity is expressed by a ratio of an amount of movement of the motion blur correction lens unit and an amount of movement of the image plane. The larger the amount of movement of the image plane, the higher is the motion blur correction sensitivity.

Moreover, it is desirable that the motion blur correction lens unit is disposed in a lens unit which is fixed in the optical axis direction. When the motion blur correction lens unit is disposed in a lens unit which moves in the optical axis direction, there is a need to improve an accuracy of a stopping position of the moving lens unit in the optical axis direction and a need to suppress an effect of shaking in a drive mechanism. When the motion blur correction lens unit is disposed in a lens unit which is fixed in the optical axis direction, since there is no such need, it is possible to improve a performance of the motion blur correction.

In the basic arrangement, the first lens unit and the third lens unit are fixed in the optical axis direction. In a case in which the image forming optical system is a telephoto lens, a diameter of a lens becomes the largest in the first lens unit. Therefore, when the motion blur correction lens unit is disposed in the first lens unit, a diameter of the motion blur correction lens unit becomes large. Consequently, it becomes difficult to make the motion blur correction lens unit light-weight.

In a case in which the rear-side lens unit is fixed in the optical axis direction, it is possible to dispose the motion blur correction lens unit in the rear-side lens unit. The rear-side lens unit is disposed near the image plane. Therefore, in the rear-side lens unit, it is possible to make a diameter of a lens comparatively small. However, it becomes difficult to improve the motion blur correction sensitivity.

For improving the motion blur correction sensitivity, the refractive power of the motion blur correction lens unit is made large. Moreover, even by disposing the motion blur correction lens unit more on the object side, it is possible to improve the motion blur correction sensitivity. However, in both the methods, a space for the movement of the second lens unit, which is the focusing unit, is narrowed. As a result, an object distance that can be focused also becomes long.

For focusing with a small space for movement, the refractive power of the second lens unit has to be made large. However, making the refractive power of the second lens unit large causes an occurrence of the spherical aberration.

As mentioned above, for improving the motion blur correction sensitivity, the refractive power of the motion blur correction lens unit is made large. However, in this method, for securing a performance of the motion blur correction lens unit, a thickness in the optical axis direction of the rear-side lens unit has to be made thick. Consequently, the overall length of the optical system becomes long.

In the basic arrangement, a telephoto optical system is formed by the first lens unit and the second lens unit. The third lens unit is positioned on the image side of the second lens unit. Accordingly, the third lens unit is positioned on the image side of the telephoto optical system.

On the image side of the telephoto optical system, a light-beam diameter is narrowed. Therefore, in the third lens unit, an axial light beam and an off-axis light beam overlap. As a result, in the third lens unit, it is possible to increase the amount of movement of the image plane by a movement of a lens, while the lens has a small diameter.

For such reasons, in the basic arrangement, the motion blur correction lens unit is disposed in the third lens unit. By making such arrangement, it becomes easy to achieve high motion blur correction sensitivity while making the diameter of the motion blur correction lens unit small.

Moreover, the third lens unit also has a function of shortening the overall length of the optical system. Therefore, the refractive power is made large in the third lens unit. As mentioned above, in the third lens unit, the axial light beam and the off-axis light beam overlap. Therefore, the third lens unit is a lens unit significant for correction of the spherical aberration and correction of a chromatic aberration.

Therefore, it is preferable to let the refractive power be shared by the motion blur correction lens unit or to let an entire or a part of a function of aberration correction be shared by the motion blur correction lens unit. When such arrangement is made, it is possible to secure efficiently a space for the movement of the motion blur correction lens unit. Consequently, taking into consideration the overall optical system, it becomes easy to secure a space for the movement of the focusing unit. Moreover, it becomes easy to shorten the overall length of the optical system.

It is desirable that the movement of the motion blur correction lens unit is not carried out by a lens unit no other than the third lens unit. By making such arrangement, since it is possible to eliminate an external influence due to the movement of the motion blur correction lens unit, the motion blur correction control with even higher accuracy becomes possible.

Moreover, as mentioned above, the third lens unit is involved potently in shortening the overall length of the optical system and correcting the spherical aberration. Therefore, it is desirable that the third lens unit includes at least a positive lens and a negative lens. By making such arrangement, since it is possible to make the refractive power of the third lens unit large, it is possible to suppress an occurrence of the spherical aberration and an occurrence of a longitudinal chromatic aberration, while shortening the overall length of the optical system.

The image forming optical system of the first embodiment has the abovementioned basic arrangement and the following conditional expressions (1) and (2) are satisfied:

0.59≤|fMF/fMB|≤3.0 (1)

70.0≤νdFFp (2)

where,

fMF denotes a focal length of the third lens unit,

fMB denotes a focal length of the fourth lens unit, and

νdFFp denotes Abbe's number which is the maximum among Abbe's numbers for positive lenses in the first lens unit.

In a case in which a value falls below a lower limit value of conditional expression (1), the refractive power of the second lens unit becomes excessively small. In this case, a diameter of the second lens unit becomes large. Since the second lens unit is the focusing unit, the focusing unit becomes heavy. As a result, quick focusing is not possible.

Moreover, focusing sensitivity is degraded. In this case, for focusing to an object at a close distance, a space for the movement of the fourth lens unit has to be increased. Consequently, it is not possible to make the optical system small-sized. The focusing sensitivity is expressed by a ratio of an amount of movement of the focusing unit and the amount of movement of the image plane. The larger the amount of movement of the image plane, the higher is the focusing sensitivity.

In a case in which a value exceeds an upper limit value of conditional expression (1), the refractive power of the fourth lens unit becomes excessively large. In this case, since an occurrence of the spherical aberration in the fourth lens unit becomes large, it is not possible to achieve a favorable imaging performance.

When the positive refractive power of the first lens unit is made large, it is possible to shorten the overall length of the optical system. However, when the positive refractive power of the first lens unit is made large, a tendency of an increase in an occurrence of the longitudinal chromatic aberration in particular, increases.

It is preferable that at least one of the positive lenses used in the first lens unit satisfy conditional expression (2) By making such arrangement, it is possible to suppress an occurrence of the longitudinal chromatic aberration. As a result, it is possible to shorten the overall length of the optical system while improving the imaging performance of the optical system.

The image forming optical system of the second embodiment has the abovementioned basic arrangement and the following conditional expressions (2) and (3) are satisfied:

70.0≤νdFFp (2)

3.7≤LTL/fMF≤8.5 (3)

where,

fMF denotes the focal length of the third lens unit,

LTL denotes a distance from a lens surface nearest to object up to an image plane, and

νdFFp denotes the Abbe's number which is the maximum among Abbe's numbers for positive lenses in the first lens unit.

A technical significance of conditional expression (2) is as mentioned above.

In a case in which a value falls below a lower limit value of conditional expression (3), the refractive power of the third lens unit becomes excessively small. In this case, a height of a light ray incident on the fourth lens unit becomes high. Consequently, a diameter of the fourth lens unit becomes large. As a result, it becomes difficult to make the fourth lens unit light-weight. Or, the overall length of the optical system becomes short. In this case, the refractive power of the first lens unit becomes large. Consequently, a weight of the first lens unit increases.

In a case in which a value exceeds an upper limit value of conditional expression (3), a load of the refractive power on the third lens unit becomes large. In this case, an occurrence of aberration in the third lens unit becomes large. Consequently, it is not possible to achieve a favorable imaging performance. Or, the overall length of the optical system becomes long.

The image forming optical system of the third embodiment has the abovementioned basic arrangement, and the motion blur correction lens unit include a positive lens and a negative lens, and the following conditional expressions (4) and (5) are satisfied:

1.5≤|LTL/fFB|≤9.5 (4)

−2.5≤fMB/fR≤−0.15 (5)

where,

fFB denotes a focal length of the second lens unit,

LTL denotes the distance from a lens surface nearest to object up to an image plane,

fMB denotes the focal length of the fourth lens unit, and

fR denotes a focal length of the rear-side lens unit.

The motion blur correction lens unit includes at least a negative lens and a positive lens. Accordingly, it is possible to reduce an occurrence of the longitudinal chromatic aberration in the motion blur correction lens unit. As a result, it becomes easy to secure a motion blur correction performance in the motion blur correction lens unit.

In a case in which a value falls below a lower limit value of conditional expression (4), the diameter of the second lens unit becomes large. In this case, the diameter of the optical system also becomes large. Consequently, it becomes difficult to make the optical system small-sized.

In a case in which a value exceeds an upper limit value of conditional expression (4), the spherical aberration which occurs in the second lens unit becomes large. Consequently, it is not possible to achieve a favorable imaging performance.

In a case in which a value falls below a lower limit value of conditional expression (5), it becomes difficult to secure an adequate back focus. When an attempt is made to secure an adequate back focus, the refractive power of the fourth lens unit becomes large. In this case, since there is an increased tendency of the spherical aberration becoming over, it is not possible to achieve a favorable imaging performance.

In a case in which a value exceeds an upper limit value of conditional expression (5), there is an increased tendency of a distortion occurring in a plus direction. It is not preferable that a value exceed the upper limit value of conditional expression (5).

The image forming optical system of the fourth embodiment has the abovementioned basic arrangement, the third lens unit includes in order from the object side, an object-side sub unit and an image-side sub unit, the object-side sub unit includes a positive lens and a negative lens, the image-side sub unit include the motion blur correction lens unit, and the motion blur correction lens unit includes a positive lens and a negative lens.

The third lens unit includes in order from the object side, the object-side sub unit and the image-side sub unit. The object-side sub unit includes the positive lens and the negative lens.

In disposing the motion blur correction lens unit in the third lens unit, the object-side sub unit is to be disposed on the object side of the motion blur correction lens unit. By the object-side sub unit including the positive lens and the negative lens, it is possible to enhance an effect of correction of the spherical aberration in the object-side sub unit.

It is possible to use the effect of correction of the spherical aberration in the object-side sub unit for reducing an occurrence of the spherical aberration in the motion blur correction lens unit. Accordingly, it is possible to reduce the number of lenses in the motion blur correction lens unit, while reducing the occurrence of the spherical aberration in the motion blur correction lens unit. As a result, it is possible to make the motion blur correction lens unit light-weight.

The motion blur correction lens unit includes at least the positive lens and the negative lens. Accordingly, it is possible to reduce an occurrence of the longitudinal chromatic aberration in the motion blur correction lens unit. As a result, it becomes easy to secure the motion blur correction performance in the motion blur correction lens unit.

In the image forming optical system of the present embodiment, it is preferable that the first lens unit, the third lens unit, and the rear-side lens unit, at all the times, do not move in the optical axis direction.

The first lens unit is heavy, and moreover, is farthest from the image plane. When the first lens unit moves both at the time of focusing and at the time of zooming, a center of gravity of the optical system varies largely.

Therefore, the first lens unit is fixed in the optical axis direction. Accordingly, it is possible to reduce a fluctuation in a position of the center of gravity of the optical system both at the time of focusing and at the time of zooming. As a result, it is possible to secure stability at the time of photography. The photographing state of the optical system varies over a wide range due to focusing and zooming. By fixing the first lens unit in the optical axis direction, it is possible to secure stability in all photographing states.

Moreover, by keeping the rear-side lens unit fixed at all the times, it is possible to suppress an entry of dirt from an image plane side. Moreover, since the number of lenses that move on the image plane side of the third lens unit decreases, it is possible to simplify a drive mechanism. In this case, an arrangement of a drive mechanism of the fourth lens unit, which is a focusing drive unit, becomes further simple. Accordingly, a diameter of a lens barrel is made thin.

In the image forming optical system of the present embodiment, it is preferable that the motion blur correction lens unit include a positive lens and a negative lens.

The motion blur correction lens unit includes at least the negative lens and the positive lens. Accordingly, it is possible to reduce an occurrence of the longitudinal chromatic aberration in the motion blur correction lens unit. As a result, it becomes easy to secure the motion blur correction performance in the motion blur correction lens unit.

In the image forming optical system of the present embodiment, it is preferable that the following conditional expression (1) be satisfied:

0.59≤|fMF/fMB|≤3.0 (1)

where,

fMF denotes the focal length of the third lens unit,

fMB denotes the focal length of the fourth lens unit.

The technical significance of conditional expression (1) is as mentioned above.

In the image forming optical system of the present embodiment, it is preferable that the following conditional expression (3) be satisfied:

3.7≤LTL/fMF≤8.5 (3)

where,

fMF denotes the focal length of the third lens unit, and

LTL denotes the distance from the lens surface nearest to object up to the image plane.

A technical significance of conditional expression (3) is as mentioned above.

In the image forming optical system of the present embodiment, it is preferable that the following conditional expression (6) be satisfied:

0.8≤|fFF/fFB|≤5.0 (6)

where,

fFF denotes a focal length of the first lens unit, and

fFB denotes the focal length of the second lens unit.

In a case in which a value falls below a lower limit value of conditional expression (6), the refractive power of the first lens unit becomes large. When the refractive power of the first lens unit becomes large, the weight of the first lens unit increases. Consequently, it becomes difficult to make the first lens unit light-weight.

In a case in which a value exceeds an upper limit value of conditional expression (6), the telephoto effect is weakened. Consequently, it becomes difficult to shorten the overall length of the optical system.

In the image forming optical system of the present embodiment, it is preferable that the following conditional expression (7) be satisfied:

0.45≤fFB/fMB≤3.0 (7)

where,

fFB denotes the focal length of the second lens unit, and

fMB denotes the focal length of the fourth lens unit.

In a case in which a value falls below a lower limit value of conditional expression (7), an effect of correction of the image plane position in the fourth lens unit is weakened. Consequently, an amount of movement of the fourth lens unit at the time of focusing becomes large. As a result, it becomes difficult to make the optical system small-sized. Or, an occurrence of the spherical aberration in the second lens unit becomes large. Consequently, it is not possible to achieve a favorable imaging performance.

In a case in which a value exceeds an upper limit value of conditional expression (7), an occurrence of the spherical aberration in the fourth lens unit becomes large. Consequently, it is not possible to achieve a favorable imaging performance. In the image forming optical system of the present embodiment, it is preferable that the following conditional expression (8) be satisfied:

0.8≤fFF/fMF≤5.0 (8)

where,

fFF denotes the focal length of the first lens unit, and

fMF denotes the focal length of the third lens unit.

In a case in which a value falls below a lower limit value of conditional expression (8), an effect of converging a light beam in the third lens unit is weakened. In this case, it is not possible to make small a diameter of a lens positioned on the image side of the third lens unit. Consequently, small-sizing of a lens positioned on the image side of the third lens unit becomes difficult.

In a case in which a value exceeds an upper limit value of conditional expression (8), the effect of converging a light beam in the first lens unit is weakened. Consequently, it becomes difficult to shorten the overall length of the optical system.

In the image forming optical system of the present embodiment, it is preferable that the following conditional expression (9) be satisfied:

0.7≤KISA≤3.5 (9)

where,

KISA=|MGISAback×(MGISA−1)|, and here

MGISAback denotes a lateral magnification of a first predetermined optical system at the time of focusing to an object at infinity, and

MGISA denotes a lateral magnification of the motion blur correction lens unit at the time of focusing to an object at infinity, and here

the first predetermined optical system is an optical system which includes all lenses positioned on the image side of the motion blur correction lens unit, and

the lateral magnification is a lateral magnification at a telephoto end in a case in which the image forming optical system is a zoom optical system.

In a case in which a value falls below a lower limit value of conditional expression (9), when an attempt is made to achieve an effective motion blur correction effect, an amount of shift of the motion blur correction lens unit becomes excessively large. Consequently, the diameter of the motion blur correction lens unit becomes large.

In a case in which a value exceeds an upper limit value of conditional expression (9), an occurrence of the spherical aberration and an occurrence of astigmatism in the motion blur correction lens unit become large. Consequently, a degradation of the motion blur correction performance becomes large.

In the image forming optical system of the present embodiment, it is preferable that the following conditional expression (10) be satisfied:

2.5≤KMBA≤15 (10)

where,

KMBA=|MGMBAback²×(MGMBA²−1)|, and here

MGMBAback denotes a lateral magnification of a second predetermined optical system at the time of focusing to an object at infinity, and

MGMBA denotes a lateral magnification of the fourth lens unit at the time of focusing to an object at infinity, and here

the second predetermined optical system is an optical system which includes all lenses positioned on the image side of the fourth lens unit, and

the lateral magnification is a lateral magnification at a telephoto end in a case in which the image forming optical system is a zoom optical system.

In a case in which a value falls below a lower limit value of conditional expression (10), an effect of correcting the image plane position in the fourth lens unit is weakened. Consequently, in a case in which the image forming optical system is a zoom optical system, a fluctuation in the overall length of the optical system at the time of zooming becomes large. As a result, stable photographing becomes difficult.

In a case in which a value exceeds an upper limit value of conditional expression (10), an error in a position of the fourth lens unit at the time of focusing becomes large. Consequently, an error in an image forming position becomes large. As a result, it is not possible to achieve a favorable imaging performance.

In the image forming optical system of the present embodiment, it is preferable that the following conditional expression (4) be satisfied:

1.5≤|LTL/fFB|≤9.5 (4)

where,

fFB denotes the focal length of the second lens unit, and

LTL denotes the distance from a lens surface nearest to object up to an image plane.

The technical significance of conditional expression (4) is as mentioned above.

In the image forming optical system of the present embodiment, it is preferable that the following conditional expression (5) be satisfied:

−2.5≤fMB/fR≤−0.15 (5)

where,

fMB denotes the focal length of the fourth lens unit, and

fR denotes the focal length of the rear-side lens unit.

The technical significance of conditional expression (5) is as mentioned above.

In the image forming optical system of the present embodiment, it is preferable that the first lens unit include in order from the object side, a first sub unit having a positive refractive power and a second sub unit, and the second sub unit include two lenses for which signs of refractive power are different.

The first lens unit includes in order from the object side, the first sub unit and the second sub unit. The first sub unit is positioned nearest to the object in the first lens unit. By imparting positive refractive power to the first sub unit and making the positive refractive power large, it is possible to make large the refractive power of the overall first lens unit. As a result, it is possible to shorten the overall length of the optical system easily.

The second sub unit includes two lenses for which signs of refractive power are different. It is preferable that the second sub unit include a negative lens and a positive lens. In this case, it is possible to correct the longitudinal chromatic aberration favorably, as well as to correct a chromatic coma occurred in the first sub unit. Since it is possible to reduce a chromatic aberration remained in the first lens unit, it is possible to reduce a need of a chromatic aberration correction in the second lens unit. As a result, it is possible to achieve an effect of reducing the number of lenses in the second lens unit, and moreover, it becomes easy to secure a stable imaging performance at the time of zooming.

The first sub unit can include a negative lens and a positive lens. By making such arrangement, a correction of the chromatic aberration becomes easy. However, it is more desirable that the first sub unit includes a single lens which is a positive lens. By making such arrangement, it is possible to make the first lens unit light-weight.

It is preferable that the two lenses in the second sub unit be cemented. By making such arrangement, it is possible to hold the lenses stably.

In the second sub unit, it is more desirable that a lens surface nearest to the object is a convex surface and a lens surface nearest to the image is a concave surface. By making such arrangement, it is possible to reduce an occurrence of the spherical aberration in the first lens unit.

In the image forming optical system of the present embodiment, it is preferable that the first lens unit include in order from the object side, a first sub unit having a positive refractive power, a second sub unit, and a third sub unit having a positive refractive power, and the second sub unit include two lenses for which signs of refractive power are different.

A technical significance of the refractive power of the first sub unit and a technical significance of the arrangement of the second sub unit are as mentioned above.

The third sub unit having a positive refractive power is disposed on the image side of the second sub unit. By making such arrangement, correction of the spherical aberration in the first lens unit becomes easier. As a result, it is possible to achieve a more favorable imaging performance.

In the third sub unit, it is more desirable that a lens surface nearest to the object is a convex surface and a lens surface nearest to the image is a concave surface. By making such arrangement, correction of the spherical aberration in the first lens unit becomes easier. Moreover, it is more desirable that the third sub unit includes one positive lens. When such arrangement is made, the first lens unit is made light-weight.

In the image forming optical system of the present embodiment, it is preferable that the third lens unit include in order from an object side, an object-side sub unit and an image-side sub unit, the object-side sub unit includes the positive lens and the negative lens, and the image-side sub unit includes the motion blur correction lens unit.

A technical significance of the object-side sub unit, the image-side sub unit, and the motion blur correction lens unit is as described in the image forming optical system of the fourth embodiment.

In the image forming optical system of the present embodiment, it is preferable that the third lens unit include in order from the object side, an object-side sub unit and an image-side sub unit, the object-side sub unit include the positive lens and the negative lens, the image-side sub unit include the motion blur correction lens unit, and the motion blur correction lens unit include the positive lens and the negative lens.

A technical significance of the object-side sub unit, the image-side sub unit, and the motion blur correction lens unit is as described in the image forming optical system of the fourth embodiment.

In the image forming optical system of the present embodiment, it is preferable that the motion blur correction lens unit have a positive refractive power.

By imparting positive refractive power to the motion blur correction lens unit, the motion blur correction lens unit having a refractive power with a sign same as that of the refractive power of the third lens unit is disposed in the third lens unit. In this case, since it is possible to make the positive refractive power of the third lens unit large, it becomes easy to shorten the overall length of the optical system.

In the image forming optical system of the present embodiment, it is preferable that the motion blur correction lens unit have a positive refractive power, and the entire third lens unit is the motion blur correction lens unit.

The technical significance of the motion blur correction lens unit is as mentioned above.

By letting the entire third lens unit to be the motion blur correction lens unit, it is possible to simplify a frame arrangement of the third lens unit.

In the image forming optical system of the present embodiment, it is preferable that the motion blur correction lens unit have a negative refractive power, and the image-side sub unit include the motion blur correction lens unit and a predetermined sub unit having a positive refractive power.

By imparting negative refractive power to the motion blur correction lens unit, the motion blur correction lens unit having a refractive power of a sign opposite to that of the refractive power of the third lens unit is disposed in the third lens unit. In this case, it becomes easy to improve the motion blur correction sensitivity.

Moreover, since the positive refractive power of the third lens unit is large, the spherical aberration becomes to be under easily. By disposing the motion blur correction lens unit having a negative refractive power in the third lens unit, it is possible to suppress an occurrence of the spherical aberration on an under side. In other words, it is possible to achieve an effect of correcting the spherical aberration.

Moreover, the correction of the spherical aberration is also shared by the fourth lens unit. By achieving the effect of correction of the spherical aberration in the third lens unit, it is possible to reduce a load of correction of the spherical aberration in the fourth lens unit. As a result, it is possible to reduce a degradation of an imaging performance at the time of movement of the fourth lens unit.

When a positive refractive power is imparted to the object-side lens unit, both the refractive power on the object side of the motion blur correction lens unit and the refractive power on the image side of the motion blur correction lens unit become the positive refractive power. By making such arrangement, it becomes easier to improve the motion blur correction sensitivity.

Moreover, when a positive refractive power is imparted to the object-side sub unit, it is possible to make small a diameter of a light beam incident on the motion blur correction lens unit. Consequently, it is possible to make the diameter of the motion blur correction lens unit small. In this case, since the motion blur correction lens unit is made light-weight, it is possible to carry out the motion blur correction more quickly.

In the image forming optical system of the present embodiment, it is preferable that the motion blur correction lens unit include not less than two lenses, and a positive lens and a negative lens be included in the lenses not less than two lenses.

In the motion blur correction lens unit, when remained amount of the chromatic aberration is large, an occurrence of the chromatic coma on axis at the time of moving becomes large. Consequently, an imaging performance is degraded. By the motion blur correction lens unit including a positive lens and a negative lens, it is possible to correct the chromatic aberration in the motion blur correction lens unit. As a result, it is possible to make small the remained amount of chromatic aberration in the motion blur correction lens unit.

In the image forming optical system of the present embodiment, it is preferable that the motion blur correction lens unit include at least two positive lenses and one negative lens.

As mentioned above, the third lens unit is a significant lens unit for the correction of the spherical aberration and the correction of the chromatic aberration. By disposing two positive lenses in the third lens unit having a positive refractive power, it is possible to let the positive refractive power be shared by the two positive lenses. As a result, even when the positive refractive power is made large, it is possible to suppress an occurrence of the spherical aberration. By disposing a lens having a negative refractive power in the third lens unit, it is possible to carry out the correction of the spherical aberration and the correction of the chromatic aberration.

In the image forming optical system of the present embodiment, it is preferable that the fourth lens unit include not less than two lenses, and a positive lens and a negative lens be included in the lenses not less than two lenses include.

The fourth lens unit is a focusing unit. When remained amount of the chromatic aberration in the fourth lens unit is large, a fluctuation in the longitudinal chromatic aberration at the time of focusing becomes mainly large. As a result, an imaging performance is degraded at the time of focusing to an object at a close distance. By disposing the positive lens and the negative lens in the fourth lens unit, it is possible to correct the longitudinal chromatic aberration favorably in the fourth lens unit. As a result, it is possible to reduce degradation of the imaging performance.

In the image forming optical system of the present embodiment, it is preferable that an aperture stop be disposed from the image side of the second lens unit up to the object side of the fourth lens unit.

It is desirable to dispose the aperture stop from the image side of the second lens unit up to the object side of the fourth lens unit. When such arrangement is made, it is possible to secure symmetry of the optical system on the object side of the aperture stop and the image side of the aperture stop. As a result, it is possible to reduce an occurrence of the chromatic aberration of magnification and an occurrence of the distortion.

As mentioned above, in the basic arrangement, the telephoto optical system is formed by the first lens unit and the second lens unit. The third lens unit is positioned on the image side of the second lens unit. Therefore, the third lens unit is positioned on the image side of the telephoto optical system.

A diameter of a light beam is narrowed on the image side of the telephoto optical system. Accordingly, in the third lens unit, the axial light beam and the off-axis light beam overlap. Therefore, by disposing the aperture stop near the third lens unit, it is possible reduce a variation in an F-number at the time of focusing or a variation in the F-number at the time of zooming.

In the image forming optical system of the present embodiment, it is preferable that the second lens unit include two negative lenses and one positive lens.

In the second lens unit, particularly various aberration remained in the first lens unit are corrected. The remained various aberrations are the spherical aberration, the astigmatism, and the chromatic aberration. Correcting these various aberrations is effective for shortening the overall length of the optical system and securing an imaging performance throughout the entire zoom range.

In the first lens unit, an occurrence of the chromatic aberration and an occurrence of the spherical aberration are suppressed. Accordingly, in the second lens unit, an aberration other than the chromatic aberration and the spherical aberration is to be reduced. By the second lens unit including the two negative lenses and one positive lens, it is possible to correct the spherical aberration, the astigmatism, and the chromatic aberration. Moreover, by including three lenses in the second lens unit, it is possible to achieve an effect of small-sizing of the second lens unit and an effect of making the second lens unit light-weight.

In the image forming optical system of the present embodiment, it is preferable that the rear-side lens unit include one positive lens and one negative lens, one of the positive lens and the negative lens is positioned nearest to the image, and the other lens be disposed to be adjacent to the one of the positive lens and the negative lens.

It is preferable to dispose one positive lens and one negative lens nearest to the image in the rear-side lens unit. By making such arrangement, it is possible to correct favorably an off-axis aberration such as the distortion and the chromatic aberration of magnification.

In the image forming optical system of the present embodiment, it is preferable that the following conditional expression (11) be satisfied:

16≤νdRni≤26 (11)

where,

νdRni denotes Abbe's number for the negative lens in the rear-side lens unit.

In a case in which a value falls below a lower limit value of conditional expression (11), the correction of the chromatic aberration of magnification in the overall optical system, and particularly the correction of the chromatic aberration of magnification on a short wavelength side, becomes excessive. Consequently, an imaging performance is degraded. In a case in which a value exceeds an upper limit value of conditional expression (11), an effect of correction of the chromatic aberration of magnification in the overall optical system, and particularly correction of the chromatic aberration of magnification on the short wavelength side is weakened. Consequently, an imaging performance is degraded.

In the image forming optical system of the present embodiment, it is preferable that the following conditional expression (12) be satisfied:

0.015≤LIS/LTL≤0.2 (12)

where,

LIS denotes a total thickness on an optical axis of the motion blur correction lens unit, and

LTL denotes the distance from the lens surface nearest to object up to the image plane.

The motion blur correction lens unit includes at least the positive lens and the negative lens. Accordingly, it is possible to suppress an occurrence of the spherical aberration and an occurrence of the chromatic aberration.

In a case in which a value falls below a lower limit value of conditional expression (12), it is not possible to impart the refractive power necessary for the correction of the spherical aberration and the refractive power necessary for the correction of the chromatic aberration to the positive lens. Consequently, it is not possible to achieve a favorable imaging performance.

In a case in which a value exceeds an upper limit value of conditional expression (12), a space for the movement of the motion blur correction lens unit increases. Consequently, it is not possible to secure adequately a space for the movement of a lens unit that moves at the time of zooming or a space for the movement of a lens unit that moves at the time of focusing. When an attempt is made to secure the space for the movement, the overall length of the optical system becomes long. Consequently, it becomes difficult to shorten the overall length of the optical system.

In the image forming optical system of the present embodiment, it is preferable that the following conditional expression (2) be satisfied:

70.0≤νdFFp (2)

where,

νdFFp denotes the Abbe's number which is the maximum among Abbe's numbers for positive lenses in the first lens unit.

The technical significance of conditional expression (2) is as mentioned above.

In the image forming optical system of the present embodiment, it is preferable that the image forming optical system be a macro lens, and the focusing be carried out by moving the second lens unit and the fourth lens unit.

By making such arrangement, the focusing is possible even for an object positioned at a close distance. Moreover, it is possible to suppress the motion blur. As a result, it is possible to form a sharp optical image of the object positioned at a close distance.

In the image forming optical system of the present embodiment, it is preferable that the image forming optical system be a macro lens, and the macro lens includes in order from the object side, the first lens unit, the second lens unit, the third lens unit, the fourth lens unit, and the rear-side lens unit.

By making such arrangement, the focusing is possible even for the object positioned at a close distance, while small-sizing the optical system. Moreover, it is possible to suppress the motion blur. As a result, it is possible to form a sharp optical image of the object positioned at a close distance.

In the image forming optical system of the present embodiment, it is preferable that the image forming optical system be a zoom lens of which an angle of view varies, zooming toward a telephoto side be carried out at least by moving the second lens unit toward the image side and by moving the fourth lens unit, and focusing to the object at a close distance be carried out by moving the fourth lens unit toward the image side.

By making such arrangement, formation of an optical image of an object positioned at a long distance and focusing to the object positioned at a long distance are possible. Moreover, it is possible to suppress the motion blur. As a result, it is possible to form a sharp optical image of the object positioned at a long distance.

It is preferable that the image forming optical system of the present embodiment include a moving lens unit which moves at the time of zooming or at the time of focusing, and the moving lens unit be disposed between the fourth lens unit and the rear-side lens unit.

It is desirable to include a moving lens unit which moves at the time of zooming or at the time of focusing, apart from the second lens unit and the fourth lens unit. It is preferable to dispose the moving lens unit between the fourth lens unit and the rear-side lens unit.

Fluctuation in the astigmatism occurs in the fourth lens unit at the time of zooming or at the time of focusing. By disposing the moving lens unit near the fourth lens unit, it is possible to suppress the fluctuation in the astigmatism. By moving the moving lens unit at the time of zooming, an effect of suppressing the fluctuation in the astigmatism is enhanced.

In the image forming optical system of the present embodiment, it is preferable that the moving lens unit have a negative refractive power, and the moving lens unit move at the time of zooming.

By imparting negative refractive power to the moving lens unit, the optical system is made small-sized and light-weight. By moving the moving lens unit at the time of zooming, an effect of small-sizing of the optical system, an effect of making the optical system light-weight, and an effect of suppressing the fluctuation in the astigmatism are enhanced.

An image pickup apparatus of the present embodiment includes an optical system, and an image pickup element which has an image pickup surface, and which converts an image formed on the image pickup surface by the optical system to an electric signal, and the optical system is any one of the abovementioned image forming optical systems.

It is possible to provide an image pickup apparatus which has a superior operability and mobility, and which enables to achieve a high-quality image.

Moreover, it is preferable to satisfy simultaneously a plurality of abovementioned arrangements mutually. Moreover, an arrangement may be made such that some of the arrangements are satisfied simultaneously. For instance, an arrangement may be made such that an image forming optical system other than the abovementioned image forming optical system is used as one of the abovementioned image forming optical systems or is used in the image pickup apparatus.

Regarding conditional expressions, each conditional expression may be let to be satisfied separately. When such an arrangement is made, it is favorable as it is easy to achieve an effect of each conditional expression.

Moreover, for each conditional expression, the lower limit value and the upper limit value may be changed as shown below. Changing the upper limit value and the lower limit value as given below is favorable, as the effect of each conditional expression will be even more assured.

For conditional expression (1), it is more preferable that the lower limit value is any one of 0.65, 0.7, and 0.8, and it is more preferable that the upper limit value is any one of 2.7, 2.5, and 2.0.

For conditional expression (2), is it more preferable that the lower limit value is any one of 73, 80, and 90.

For conditional expression (3), it is more preferable that the lower limit value is either 3.9 or 4, and it is more preferable that the upper limit value is any one of 8.0, 7.0, 6.0, and 5.7.

For conditional expression (4), it is more preferable that the lower limit value is any one of 2.0, 2.5, and 3.0, and it is more preferable that the upper limit value is any one of 9.0, 8.5, 7.5, and 7.0.

For conditional expression (5), it is more preferable that the lower limit value is any one of −2.2, −1.7, and −1.3, and it is more preferable that the upper limit value is any one of −0.2, −0.25, and −0.3.

For conditional expression (6), it is more preferable that the lower limit value is any one of 0.9, 1.1, and 1.3, and it is more preferable that the upper limit value is any one of 4.5, 4.0, and 3.5.

For conditional expression (7), it is more preferable that the lower limit value is any one of 0.49, 0.51, and 0.56, and it is more preferable that the upper limit value is any one of 2.7, 2.5, and 2.2.

For conditional expression (8), it is more preferable that the lower limit value is any one of 0.9, 1.0, and 1.2, and it is more preferable that the upper limit value is any one of 4.7, 4.3, and 4.0.

For conditional expression (9), it is more preferable that the lower limit value is any one of 0.85, 1.0, and 1.2, and it is more preferable that the upper limit value is any one of 3.2, 2.7, and 2.3.

For conditional expression (10), it is more preferable that the lower limit value is either 2.7 or 2.8, and it is more preferable that the upper limit value is any one of 13, 12, and 8.

For conditional expression (11), it is more preferable that the lower limit value is either 17 or 17.5, and it is more preferable that the upper limit value is either 25 or 24.

For conditional expression (12), it is more preferable that the lower limit value is any one of 0.02, 0.023, and 0.025, and it is more preferable that the upper limit value is any one of 0.15, 0.1, and 0.07.

Examples of an image forming optical system will be described below in detail by referring to the accompanying diagrams. However, the present invention is not restricted to the examples described below. As an example of the image forming optical system, a macro lens and a zoom optical system are described.

Lens cross-sectional diagram for each example will be described below. The description is as follows for examples of macro lenses.

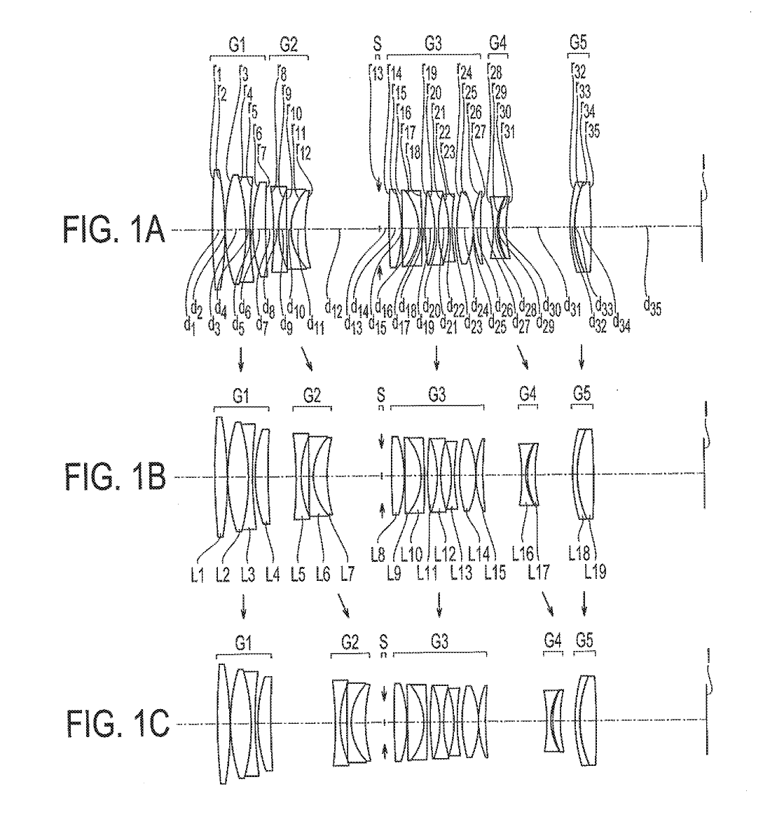

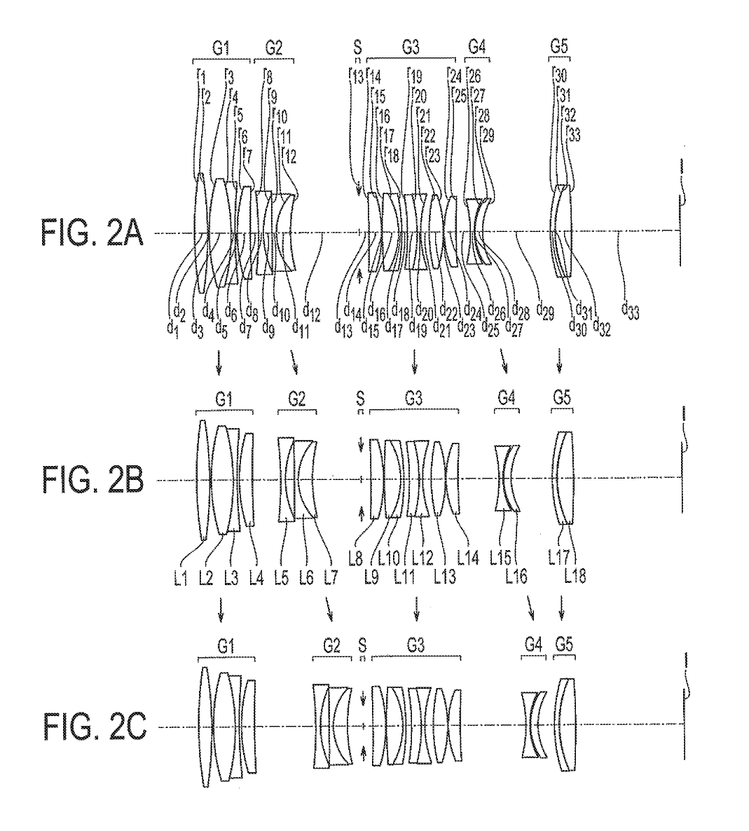

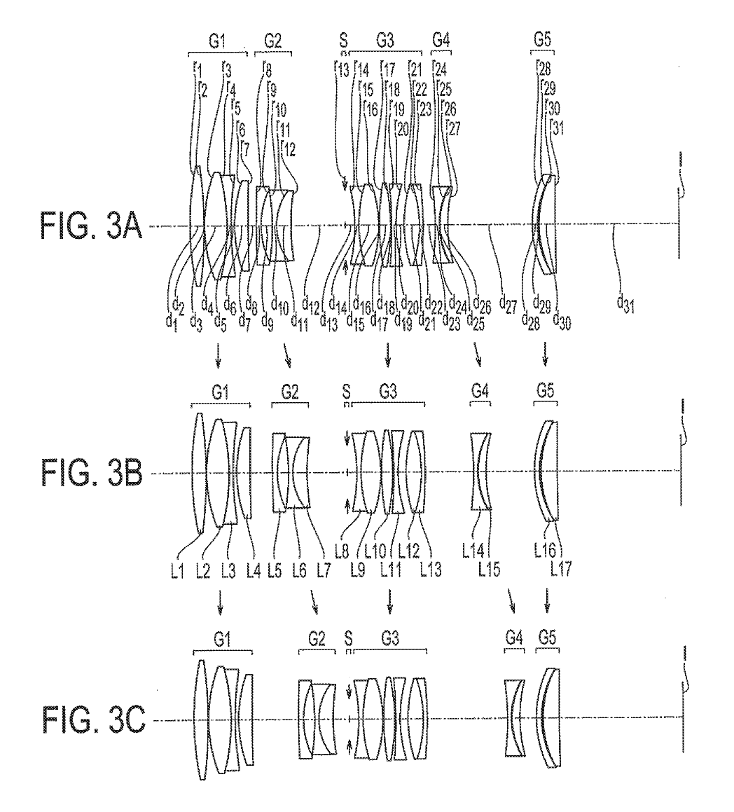

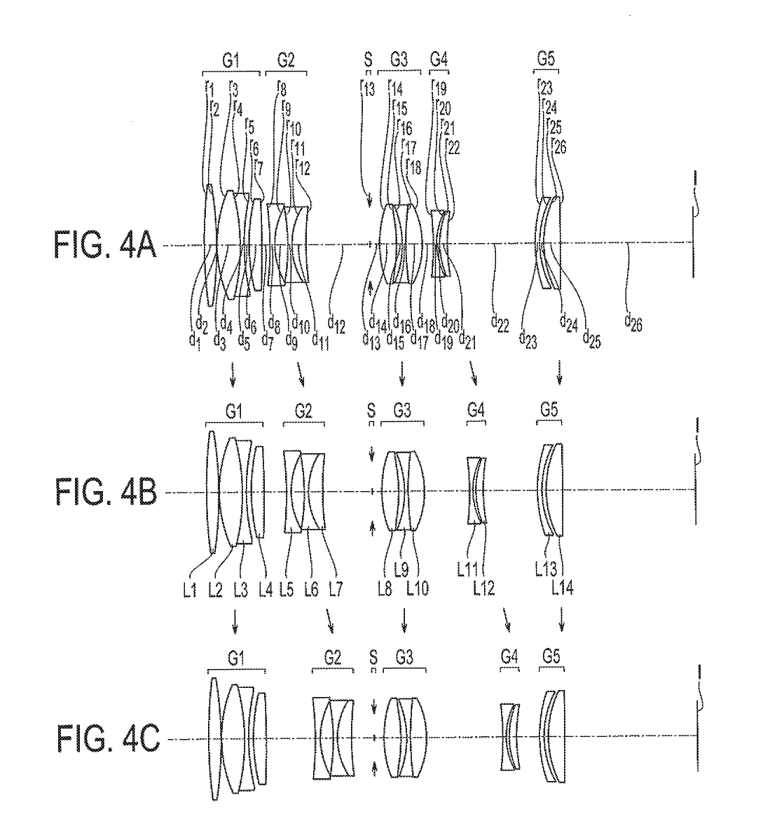

FIG. 1A, FIG. 2A, FIG. 3A, and FIG. 4A show lens cross-sectional views at the time of focusing to an object at infinity.

FIG. 1B, FIG. 2B, FIG. 3B, and FIG. 4B show lens cross-sectional views at the time of focusing to an object at a close distance.

FIG. 1C, FIG. 2C, FIG. 3C, and FIG. 4C show lens cross-sectional views at the time of focusing to an object at an extremely close distance.

Description is as follows for examples of zoom optical systems.

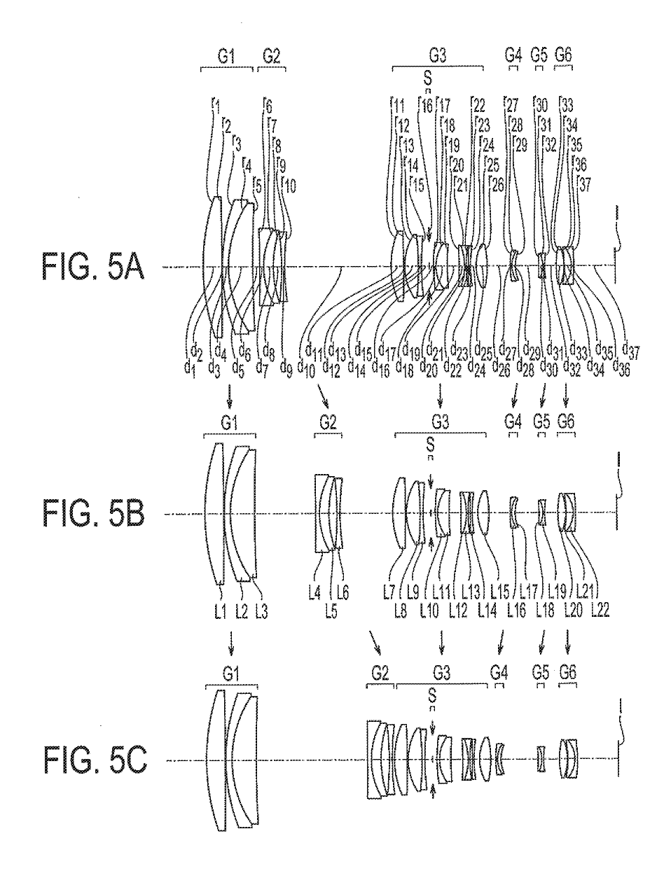

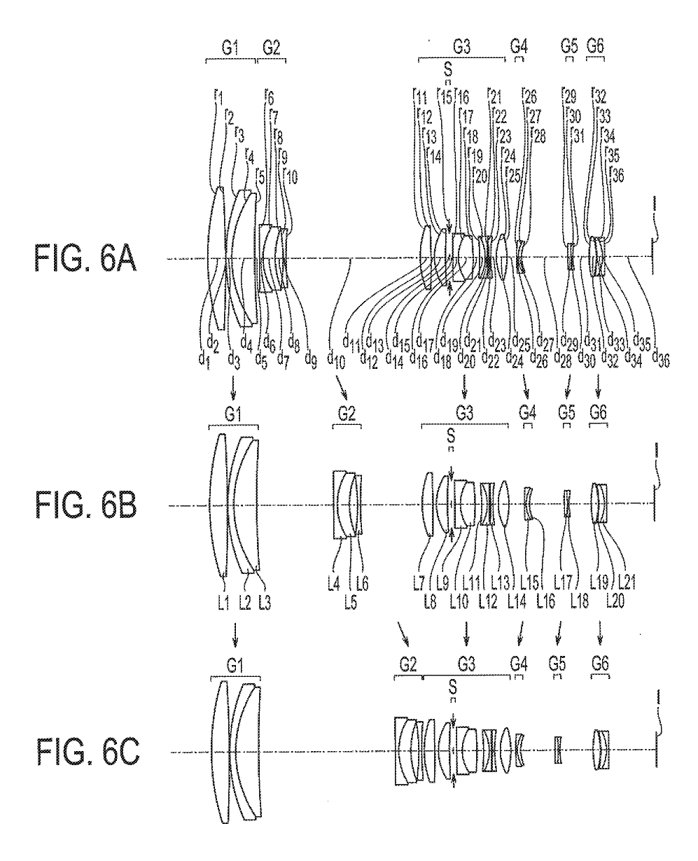

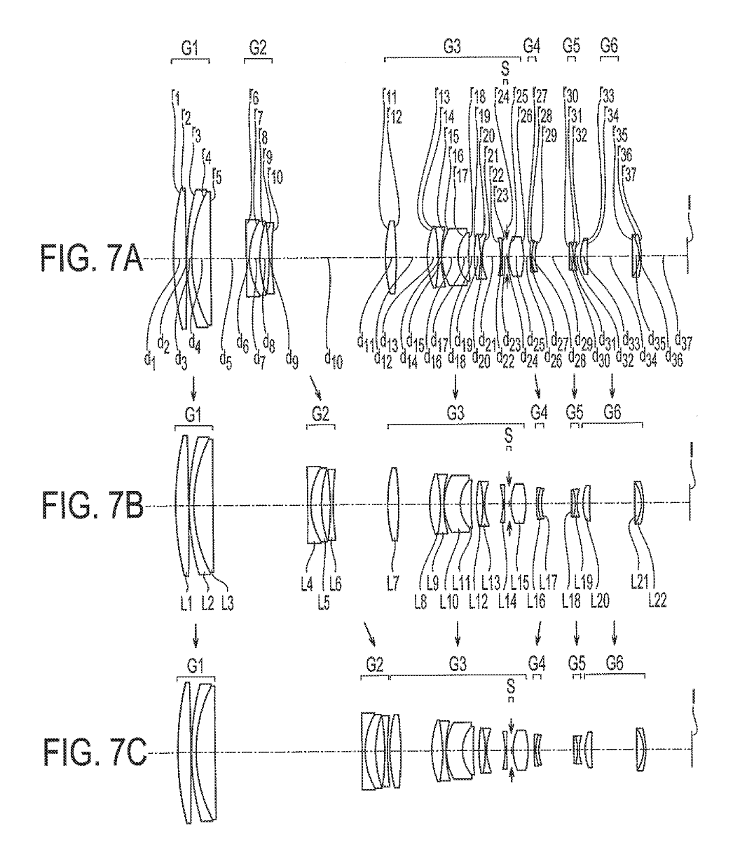

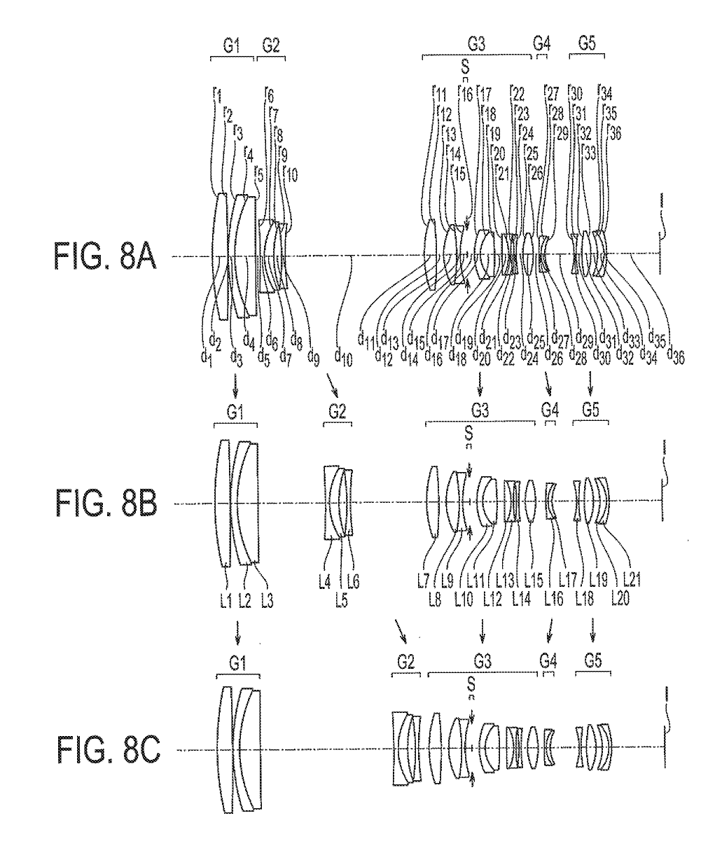

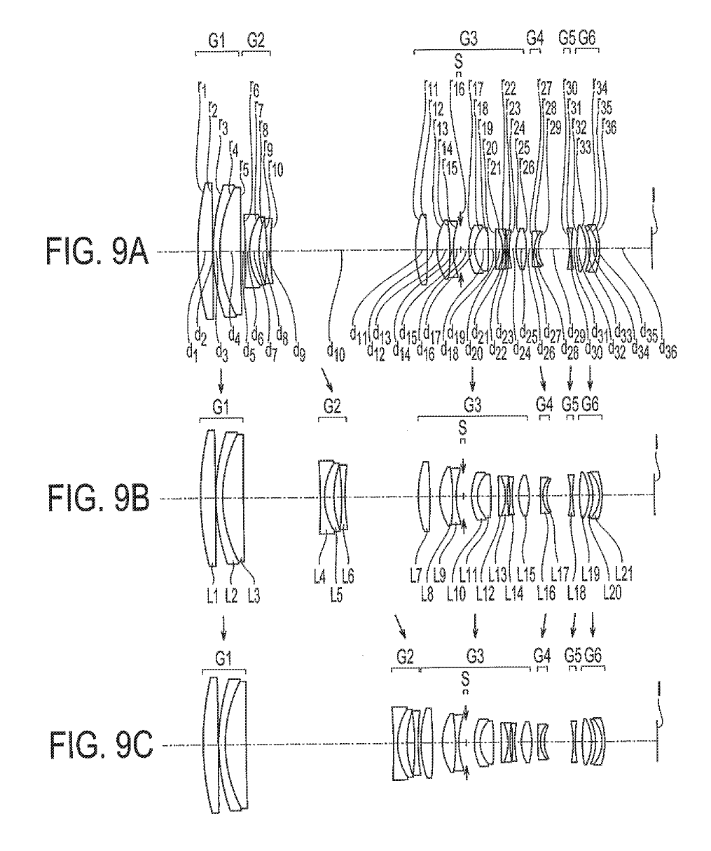

FIG. 5A, FIG. 6A, FIG. 7A, FIG. 8A, and FIG. 9A show lens cross-sectional views at a wide angle end.

FIG. 5B, FIG. 6B, FIG. 7B, FIG. 8B, and FIG. 9B show lens cross-sectional views in an intermediate focal length state.

FIG. 5C, FIG. 6C, FIG. 7C, FIG. 8C, and FIG. 9C show lens cross-sectional views at a telephoto end.

Aberration diagrams for each example will be described below. Description is as follows for the examples of the macro lenses.

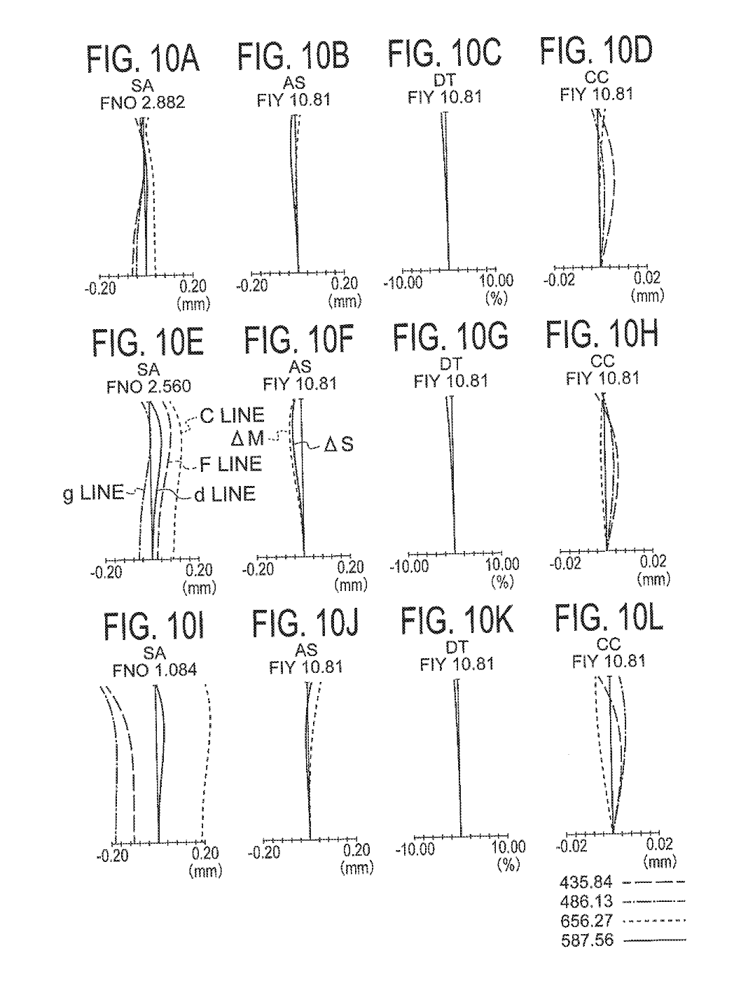

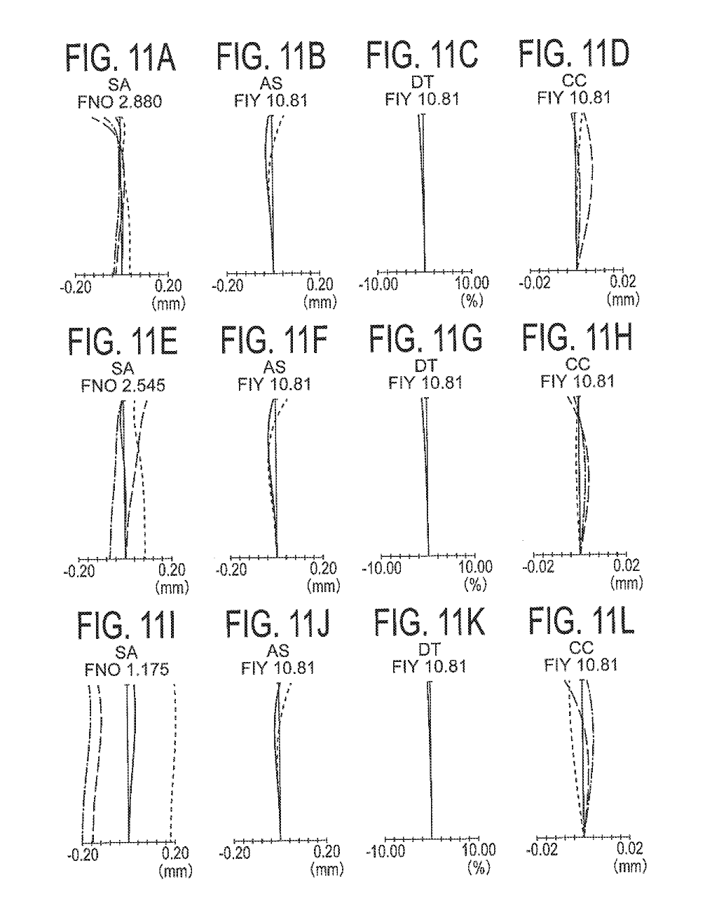

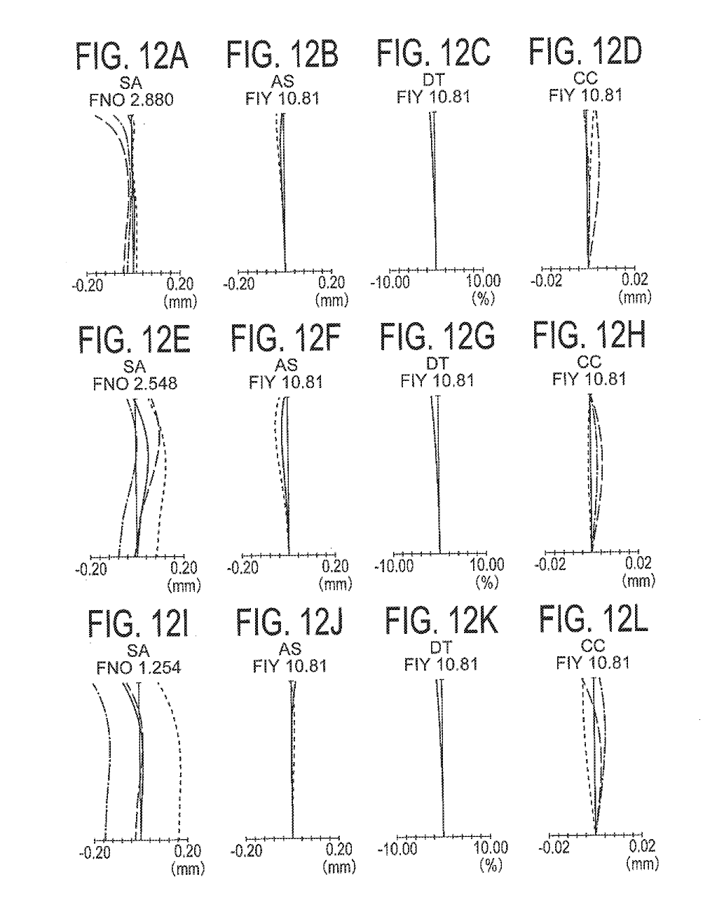

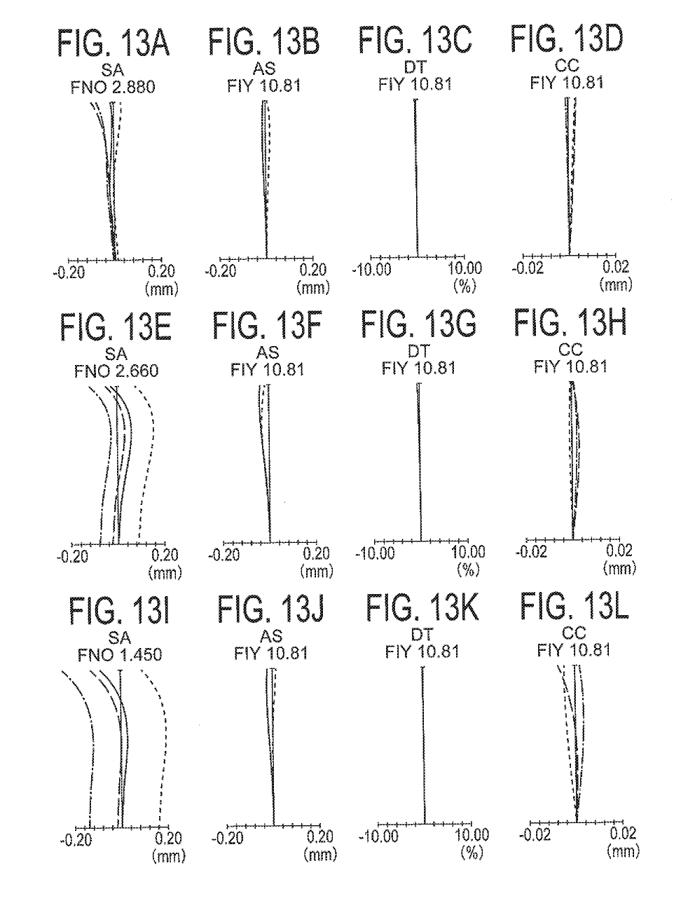

FIG. 10A, FIG. 11A, FIG. 12A, and FIG. 13A show a spherical aberration (SA) at the time of focusing to an object at infinity.

FIG. 10B, FIG. 11B, FIG. 12B, and FIG. 13B show an astigmatism (AS) at the time of focusing to an object at infinity.

FIG. 10C, FIG. 11C, FIG. 12C, and FIG. 13C show a distortion (DT) at the time of focusing to an object at infinity.

FIG. 10D, FIG. 11D, FIG. 12D, and FIG. 13D show a chromatic aberration of magnification (CC) at the time of focusing to an object at infinity.

FIG. 10E, FIG. 11E, FIG. 12E, and FIG. 13E show a spherical aberration (SA) at the time of focusing to an object at a close distance.

FIG. 10F, FIG. 11F, FIG. 12F, and FIG. 13F show an astigmatism (AS) at the time of focusing to an object at a close distance.

FIG. 10G, FIG. 11G, FIG. 12G, and FIG. 13G show a distortion (DT) at the time of focusing to an object at a close distance.

FIG. 10H, FIG. 11H, FIG. 12H, and FIG. 13H show a chromatic aberration of magnification (CC) at the time of focusing to an object at a close distance.

FIG. 10I, FIG. 11I, FIG. 12I, and FIG. 13I show a spherical aberration (SA) at the time of focusing to an object at an extremely close distance.

FIG. 10J, FIG. 11J, FIG. 12J, and FIG. 13J show an astigmatism (AS) at the time of focusing to an object at an extremely close distance.

FIG. 10K, FIG. 11K, FIG. 12K, and FIG. 13K show a distortion (DT) at the time of focusing to an object at an extremely close distance.

FIG. 10L, FIG. 11L, FIG. 12L, and FIG. 13L show a chromatic aberration of magnification (CC) at the time of focusing to an object at an extremely close distance.

Description is as follows for the examples of the zoom optical systems.

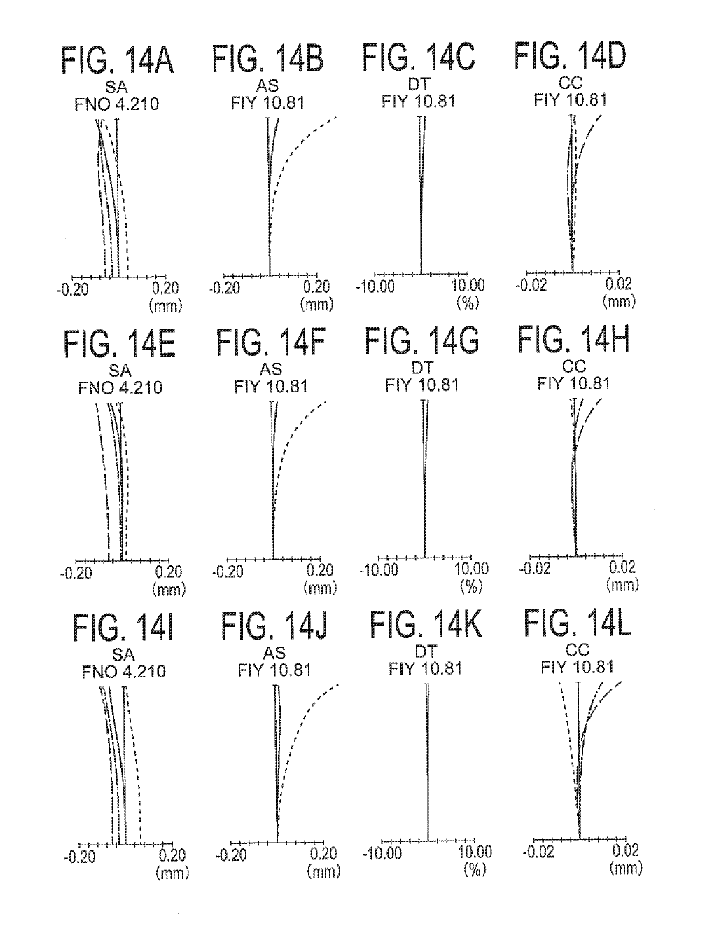

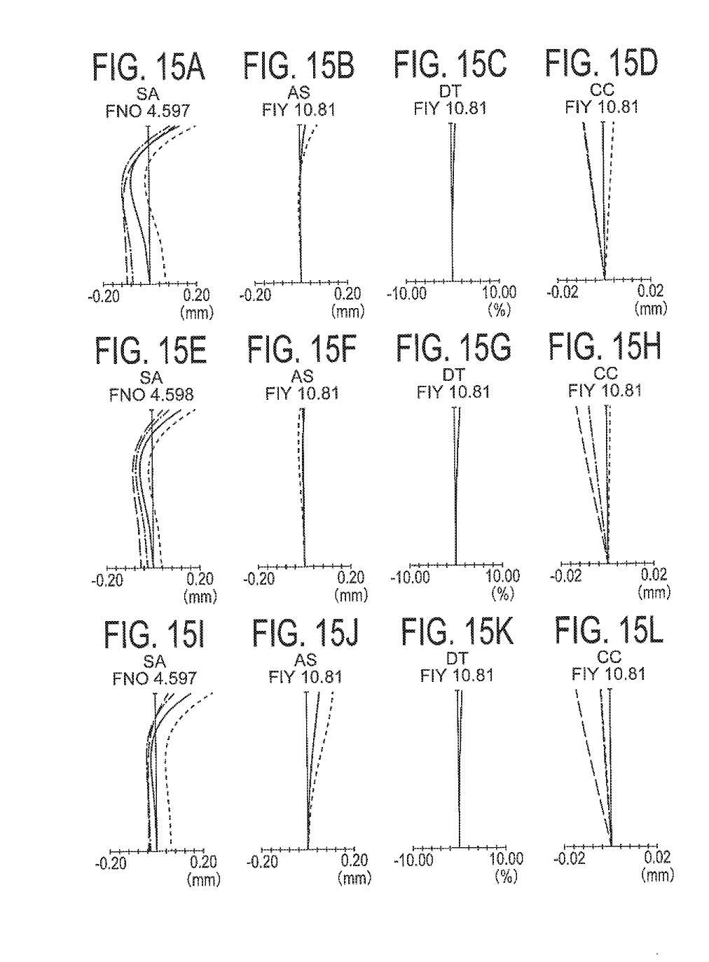

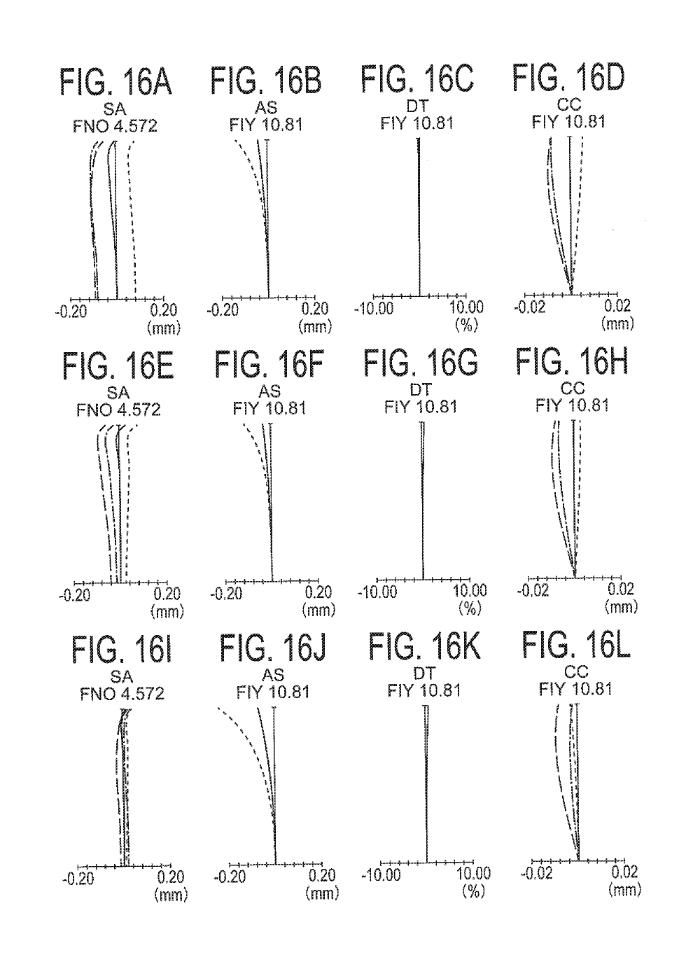

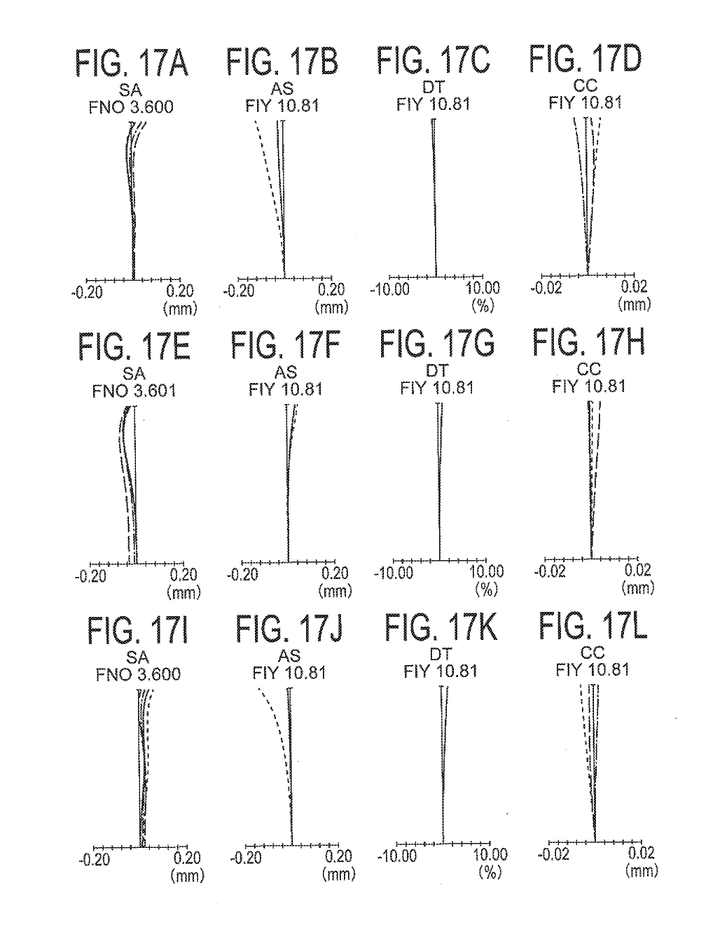

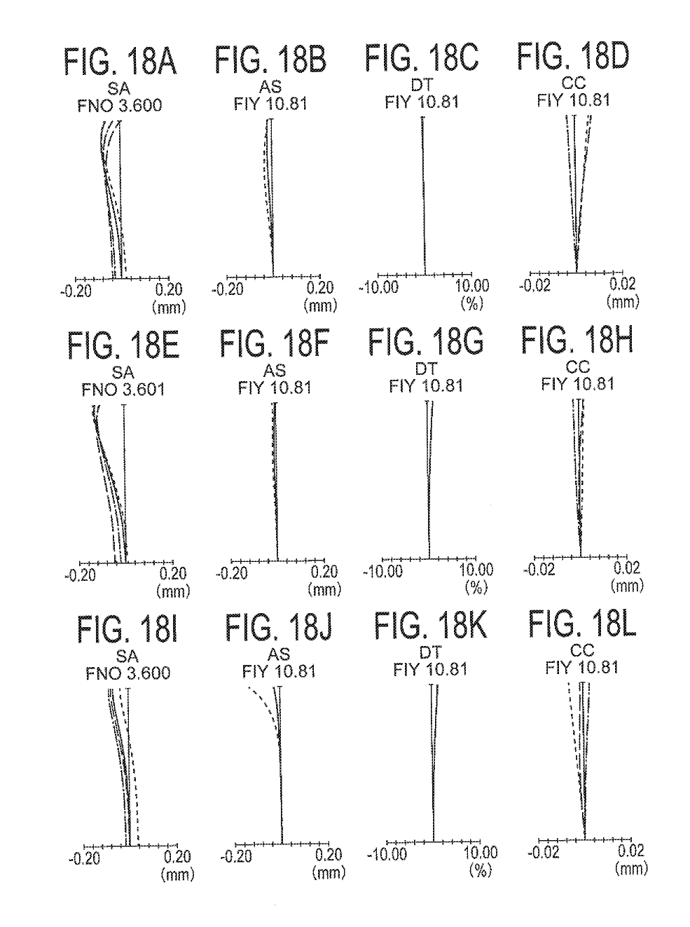

FIG. 14A, FIG. 15A, FIG. 16A, FIG. 17A, and FIG. 18A show a spherical aberration (SA) at the wide angle end.

FIG. 14B, FIG. 15B, FIG. 16B, FIG. 17B, and FIG. 18B show an astigmatism (AS) at the wide angle end.

FIG. 14C, FIG. 15C, FIG. 16C, FIG. 17C, and FIG. 18C show a distortion (DT) at the wide angle end.

FIG. 14D, FIG. 15D, FIG. 16D, FIG. 17D, and FIG. 18D show a chromatic aberration of magnification (CC) at the wide angle end.

FIG. 14E, FIG. 15E, FIG. 16E, FIG. 17E, and FIG. 18E show a spherical aberration (SA) in the intermediate focal length state.

FIG. 14F, FIG. 15F, FIG. 16F, FIG. 17F, and FIG. 18F show an astigmatism (AS) in the intermediate focal length state.

FIG. 14G, FIG. 15G, FIG. 16G, FIG. 17G, and FIG. 18G show a distortion (DT) in the intermediate focal length state.

FIG. 14H, FIG. 15H, FIG. 16H, FIG. 17H, and FIG. 18H show a chromatic aberration of magnification (CC) in the intermediate focal length state.

FIG. 14I, FIG. 15I, FIG. 16I, FIG. 17I, and FIG. 18I show a spherical aberration (SA) at the telephoto end.

FIG. 14J, FIG. 15J, FIG. 16J, FIG. 17J, and FIG. 18J show an astigmatism (AS) at the telephoto end.

FIG. 14K, FIG. 15K, FIG. 16K, FIG. 17K, and FIG. 18K show a distortion (DT) at the telephoto end.

FIG. 14L, FIG. 15L, FIG. 16L, FIG. 17L, and FIG. 18L show a chromatic aberration of magnification at the telephoto end.

In the examples of the zoom optical system, the lens cross-sectional views are lens cross-sectional views at the time of focusing to an object at infinity. The aberration diagrams are aberration diagrams at the time of focusing to an object at infinity.

A first lens unit is denoted by G1, a second lens unit is denoted by G2, a third lens unit is denoted by G3, a fourth lens unit is denoted by G4, a fifth lens unit is denoted by G5, a sixth lens unit is denoted by G6, an aperture stop is denoted by S, and an image plane (image pickup surface) is denoted by I.

An example 1 is an example of a macro lens. The macro lens includes in order from an object side, a first lens unit G1 having a positive refractive power, a second lens unit G2 having a negative refractive power, a third lens unit G3 having a positive refractive power, a fourth lens unit G4 having a negative refractive power, and a fifth lens unit G5 having a positive refractive power. An aperture stop (stop) S is disposed between the second lens unit G2 and the third lens unit G3.

The first lens unit G1 includes a biconvex positive lens L1, a biconvex positive lens L2, a biconcave negative lens L3, and a positive meniscus lens L4 having a convex surface directed toward the object side. Here, the biconvex positive lens L2 and the biconcave negative lens L3 are cemented.

The second lens unit G2 includes a biconcave negative lens L5, a negative meniscus lens L6 having a convex surface directed toward the object side, and a positive meniscus lens L7 having a convex surface directed toward the object side. Here, the negative meniscus lens L6 and the positive meniscus lens L7 are cemented.

The third lens unit G3 includes a biconvex positive lens L8, a positive meniscus lens L9 having a convex surface directed toward an image side, a negative meniscus lens L10 having a convex surface directed toward the image side, a biconcave negative lens L12, a biconcave negative lens L13, a biconvex positive lens L14, and a positive meniscus lens L15 having a convex surface directed toward the object side. Here, the positive meniscus lens L9 and the negative meniscus lens L10 are cemented. The biconvex positive lens L11 and the biconcave negative lens L12 are cemented.

The fourth lens unit G4 includes a biconcave negative lens L16 and a positive meniscus lens L17 having a convex surface directed toward the object side.

The fifth lens unit G5 includes a negative meniscus lens L18 having a convex surface directed toward the object side and a biconvex positive lens L19.

At a time of focusing from an object at infinity to an object at an extremely close distance, the first lens unit G1, the third lens unit G3, and the fifth lens unit G5 are fixed. Both the second lens unit G2 and the fourth lens unit G4 move toward the image side. At a time of image blur correction, the biconvex positive lens L11, the biconcave negative lens L12, and the biconcave negative lens L13 move in a direction perpendicular to an optical axis.

An aspheric surface is provided to a total of four surfaces, which are both surfaces of the biconvex positive lens L14 and both surfaces of the biconcave negative lens L16.

An example 2 is an example of a macro lens. The macro lens includes in order from an object side, a first lens unit G1 having a positive refractive power, a second lens unit G2 having a negative refractive power, a third lens unit G3 having a positive refractive power, a fourth lens unit G4 having a negative refractive power, and a fifth lens unit G5 having a positive refractive power. An aperture stop (stop) S is disposed between the second lens unit G2 and the third lens unit G3.

The first lens unit G1 includes a biconvex positive lens L1, a biconvex positive lens L2, a biconcave negative lens L3, and a positive meniscus lens L4 having a convex surface directed toward the object side. Here, the biconvex positive lens L2 and the biconcave negative lens L3 are cemented.

The second lens unit G2 includes a biconcave negative lens L5, a biconcave negative lens L6, and a positive meniscus lens L7 having a convex surface directed toward the object side. Here, the biconcave negative lens L16 and the positive meniscus lens L7 are cemented.

The third lens unit G3 includes a positive meniscus lens L8 having a convex surface directed toward an image side, a biconvex positive lens L9, a negative meniscus lens L10 having a convex surface directed toward the image side, a positive meniscus lens L11 having a convex surface directed toward the image side, a biconcave negative lens L12, a biconvex positive lens L13, and a positive meniscus lens L14 having a convex surface directed toward the object side. Here, the biconvex positive lens L9 and the negative meniscus lens L10 are cemented. The positive meniscus lens L11 and the biconcave negative lens L12 are cemented.

The fourth lens unit G4 includes a biconcave negative lens L15 and a positive meniscus lens L16 having a convex surface directed toward the object side.

The fifth lens unit G5 includes a negative meniscus lens L17 having a convex surface directed toward the object side and a biconvex positive lens L18.

At a time of focusing from an object at infinity to an object at an extremely close distance, the first lens unit G1, the third lens unit G3, and the fifth lens unit G5 are fixed. Both the second lens unit G2 and the fourth lens unit G4 move toward the image side. At a time of image blur correction, the positive meniscus lens L11 and the biconcave negative lens L12 move in a direction perpendicular to an optical axis.

An aspheric surface is provided to a total of three surfaces, which are an image-side surface of the biconcave negative lens L12 and both surfaces of the biconcave negative lens L15.

An example 3 is an example of a macro lens. The macro lens includes in order from an object side, a first lens unit G1 having a positive refractive power, a second lens unit G2 having a negative refractive power, a third lens unit G3 having a positive refractive power, a fourth lens unit G4 having a negative refractive power, and a fifth lens unit G5 having a positive refractive power. An aperture stop (stop) S is disposed between the second lens unit G2 and the third lens unit G3.

The first lens unit G1 includes a biconvex positive lens L1, a biconvex positive lens L2, a biconcave negative lens L3, and a positive meniscus lens L4 having a convex surface directed toward the object side. Here, the biconvex positive lens L2 and the biconcave negative lens L3 are cemented.

The second lens unit G2 includes a negative meniscus lens L5 having a convex surface directed toward the object side, a biconcave negative lens L6, and a positive meniscus lens L7 having a convex surface directed toward the object side. Here, the biconcave negative lens L6 and the positive meniscus lens L7 are cemented.

The third lens unit G3 includes a biconcave negative lens L8, a biconvex positive lens L9, a biconvex positive lens L10, a biconcave negative lens L11, a biconvex positive lens L12, and a negative meniscus lens L13 having a convex surface directed toward an image side. Here, the biconcave negative lens L8 and the biconvex positive lens L9 are cemented. The biconvex positive lens L12 and the negative meniscus lens L13 are cemented.

The fourth lens unit G4 includes a biconcave negative lens L14 and a positive meniscus lens L15 having a convex surface directed toward the object side.

The fifth lens unit G5 includes a negative meniscus lens L16 having a convex surface directed toward the object side and a positive meniscus lens L17 having a convex surface directed toward the object side.

At a time of focusing from an object at infinity to an object at an extremely close distance, the first lens unit G1, the third lens unit G3, and the fifth lens unit G5 are fixed. Both the second lens unit G2 and the fourth lens unit G4 move toward the image side. At a time of image blur correction, the biconvex positive lens L12 and the negative meniscus lens L13 move in a direction perpendicular to an optical axis.

An aspheric surface is provided to a total of three surfaces, which are an object-side surface of the biconvex positive lens L12 and both surfaces of the biconcave negative lens L14.

An example 4 is an example of a macro lens. The macro lens includes in order from an object side, a first lens unit G1 having a positive refractive power, a second lens unit G2 having a negative refractive power, a third lens unit G3 having a positive refractive power, a fourth lens unit G4 having a negative refractive power, and a fifth lens unit G5 having a positive refractive power. An aperture stop (stop) S is disposed between the second lens unit G2 and the third lens unit G3.

The first lens unit G1 includes a biconvex positive lens L1, a biconvex positive lens L2, a biconcave negative lens L3, and a biconvex positive lens L4. Here, the biconvex positive lens L2 and the biconcave negative lens L3 are cemented.

The second lens unit G2 includes a biconcave negative lens L5, a biconcave negative lens L6, and a positive meniscus lens L7 having a convex surface directed toward the object side. Here, the biconcave negative lens L6 and the positive meniscus lens L7 are cemented.

The third lens unit G3 includes a biconvex positive lens L8, a biconcave negative lens L9, and a biconvex positive lens L10. Here, the biconcave negative lens L9 and the biconvex positive lens L10 are cemented.

The fourth lens unit G4 includes a biconcave negative lens L11 and a positive meniscus lens L12 having a convex surface directed toward the object side.

The fifth lens unit G5 includes a negative meniscus lens L13 having a convex surface directed toward the object side and a biconvex positive lens L14.

At a time of focusing from an object at infinity to an object at an extremely close distance, the first lens unit G1, the third lens unit G3, and the fifth lens unit G5 are fixed. Both the second lens unit G2 and the fourth lens unit G4 move toward an image side. At a time of image blur correction, the biconvex positive lens L8, the biconcave negative lens L9, and the biconvex positive lens L10 move in a direction perpendicular to an optical axis.

An aspheric surface is provided to a total of four surfaces, which are both surfaces of the biconvex positive lens L8 and both surfaces of the biconcave negative lens L11.

An example 5 is an example of a zoom optical system. The zoom optical system includes in order from an object side, a first lens unit G1 having a positive refractive power, a second lens unit G2 having a negative refractive power, a third lens unit G3 having a positive refractive power, a fourth lens unit G4 having a negative refractive power, a fifth lens unit G5 having a negative refractive power, and a sixth lens unit G6 having a positive refractive power. An aperture stop (stop) S is disposed in the third lens unit G3.

The first lens unit G1 includes a biconvex positive lens L1, a negative meniscus lens L2 having a convex surface directed toward the object side, and a positive meniscus lens L3 having a convex surface directed toward the object side. Here, the negative meniscus lens L2 and the positive meniscus lens L3 are cemented.

The second lens unit G2 includes a biconcave negative lens L4, a positive meniscus lens L5 having a convex surface directed toward the object side, and a biconcave negative lens L6. Here, the biconcave negative lens L4 and the positive meniscus lens L5 are cemented.

The third lens unit G3 includes a biconvex positive lens L7, a biconvex positive lens L8, a biconcave negative lens L9, a negative meniscus lens L10 having a convex surface directed toward the object side, a positive meniscus lens L11 having a convex surface directed toward the object side, a positive meniscus lens L12 having a convex surface directed toward an image side, a biconcave negative lens L13, a biconcave negative lens L14, and a biconvex positive lens L15.

Here, the biconvex positive lens L8 and the biconcave negative lens L9 are cemented. The negative meniscus lens L10 and the positive meniscus lens L11 are cemented. The positive meniscus lens L12 and the biconcave negative lens L13 are cemented.

The fourth lens unit G4 includes a negative meniscus lens L16 having a convex surface directed toward the object side and a positive meniscus lens L17 having a convex surface directed toward the object side. Here, the negative meniscus lens L16 and the positive meniscus lens L17 are cemented.

The fifth lens unit G5 includes a positive meniscus lens L18 having a convex surface directed toward the image side and a biconcave negative lens L19. Here, the positive meniscus lens L18 and the biconcave negative lens L19 are cemented.

The sixth lens unit G6 includes a biconvex positive lens L20, a positive meniscus lens L21 having a convex surface directed toward the image side, and a negative meniscus lens L22 having a convex surface directed toward the image side. Here, the positive meniscus lens L21 and the negative meniscus lens L22 are cemented.

At a time of zooming from a wide angle end to a telephoto end, the first lens unit G1, the third lens unit G3, and the sixth lens unit G6 are fixed. The second lens unit G2 moves toward the image side. The fourth lens unit G4 and the fifth lens unit G5 move toward the object side. The aperture stop S is fixed together with the third lens unit G3.

At a time of focusing from a far point to a near point, both the fourth lens unit G4 and the fifth lens unit G5 move toward the image side. At a time of image blur correction, the positive meniscus lens L12, the biconcave negative lens L13, and the biconcave negative lens L14 move in a direction perpendicular to an optical axis.

An aspheric surface is provided to a total of two surfaces, which are both surfaces of the biconvex positive lens L15.

An example 6 is an example of a zoom optical system. The zoom optical system includes in order from an object side, a first lens unit G1 having a positive refractive power, a second lens unit G2 having a negative refractive power, a third lens unit G3 having a positive refractive power, a fourth lens unit G4 having a negative refractive power, a fifth lens unit G5 having a negative refractive power, and a sixth lens unit G6 having a positive refractive power. An aperture stop (stop) S is disposed in the third lens unit G3.

The first lens unit G1 includes a biconvex positive lens L1, a negative meniscus lens L2 having a convex surface directed toward the object side, and a positive meniscus lens L3 having a convex surface directed toward the object side. Here, the negative meniscus lens L2 and the positive meniscus lens L3 are cemented.

The second lens unit G2 includes a biconcave negative lens L4, a positive meniscus lens L5 having a convex surface directed toward the object side, and a biconcave negative lens L6. Here, the biconcave negative lens L4 and the positive meniscus lens L5 are cemented.

The third lens unit G3 includes a biconvex positive lens L7, a positive meniscus lens L8 having a convex surface directed toward the object side, a biconcave negative lens L9, a biconvex positive lens L10, a positive meniscus lens L11 having a convex surface directed toward an image side, a biconcave negative lens L12, a biconcave negative lens L13, and a biconvex positive lens L14.

Here, the biconcave negative lens L9 and the biconvex positive lens L10 are cemented. The positive meniscus lens L11 and the biconcave negative lens L12 are cemented.

The fourth lens unit G4 includes a negative meniscus lens L15 having a convex surface directed toward the object side and a positive meniscus lens L16 having a convex surface directed toward the object side. Here, the negative meniscus lens L15 and the positive meniscus lens L16 are cemented.

The fifth lens unit G5 includes a biconvex positive lens L17 and a biconcave negative lens L18. Here, the biconvex positive lens L17 and the biconcave negative lens L18 are cemented.

The sixth lens unit G6 includes a biconvex positive lens L19, a positive meniscus lens L20 having a convex surface directed toward the image side, and a negative meniscus lens L21 having a convex surface directed toward the image side. Here, the positive meniscus lens L20 and the negative meniscus lens L21 are cemented.

At a time of zooming from a wide angle end to a telephoto end, the first lens unit G1, the third lens unit G3, and the sixth lens unit G6 are fixed. The second lens unit G2 moves toward the image side. The fourth lens unit G4, after moving toward the image side, moves toward the object side. The fifth lens unit G5 moves toward the object side. The aperture stop S is fixed together with the third lens unit G3.

At a time of focusing from a far point to a near point, both the fourth lens unit G4 and the fifth lens unit G5 move toward the image side. At a time of image blur correction, the positive meniscus lens L11, the biconcave negative lens L12, and the biconcave negative lens L13 move in a direction perpendicular to an optical axis.

An aspheric surface is provided to a total of two surfaces, which are an image-side surface of the biconvex positive lens L10 and an object-side surface of the biconvex positive lens L14.

An example 7 is an example of a zoom optical system. The zoom optical system includes in order from an object side, a first lens unit G1 having a positive refractive power, a second lens unit G2 having a negative refractive power, a third lens unit G3 having a positive refractive power, a fourth lens unit G4 having a negative refractive power, a fifth lens unit G5 having a negative refractive power, and a sixth lens unit G6 having a positive refractive power. An aperture stop (stop) S is disposed in the third lens unit G3.

The first lens unit G1 includes a biconvex positive lens L1, a negative meniscus lens L2 having a convex surface directed toward the object side, and a positive meniscus lens L3 having a convex surface directed toward the object side. Here, the negative meniscus lens L2 and the positive meniscus lens L3 are cemented.

The second lens unit G2 includes a biconcave negative lens L4, a positive meniscus lens L5 having a convex surface directed toward the object side, and a biconcave negative lens L6. Here, the biconcave negative lens L4 and the positive meniscus lens L5 are cemented.

The third lens unit G3 includes a biconvex positive lens L7, a biconvex positive lens L8, a biconcave negative lens L9, a negative meniscus lens L10 having a convex surface directed toward the object side, a positive meniscus lens L11 having a convex surface directed toward the object side, a biconvex positive lens L12, a biconcave negative lens 113, a biconcave negative lens L14, and a biconvex positive lens L15.

Here, the biconvex positive lens L8 and the biconcave negative lens L9 are cemented. The negative meniscus lens L10 and the positive meniscus lens L11 are cemented. The biconvex positive lens L12 and the biconcave negative lens L13 are cemented.

The fourth lens unit G4 includes a negative meniscus lens L16 having a convex surface directed toward the object side and a positive meniscus lens L17 having a convex surface directed toward the object side. Here, the negative meniscus lens L16 and the positive meniscus lens L17 are cemented.

The fifth lens unit G5 includes a positive meniscus lens L18 having a convex surface directed toward an image side and a biconcave negative lens L19. Here, the positive meniscus lens L18 and the biconcave negative lens L19 are cemented.

The sixth lens unit G6 includes a positive meniscus lens L20 having a convex surface directed toward the object side, a positive meniscus lens L21 having a convex surface directed toward the image side, and a negative meniscus lens L22 having a convex surface directed toward the image side. Here, the positive meniscus lens L21 and the negative meniscus lens L22 are cemented.

At a time of zooming from a wide angle end to a telephoto end, the first lens unit G1, the third lens unit G3, and the sixth lens unit G6 are fixed. The second lens unit G2 moves toward the image side. The fourth lens unit G4, after moving toward the image side, moves toward the object side. The fifth lens unit G5, after moving toward the object side, moves toward the image side. The aperture stop S is fixed together with the third lens unit G3. An amount of movement of the fifth lens unit G5 is extremely small.

At a time of focusing from a far point to a near point, both the fourth lens unit G4 and the fifth lens unit G5 move toward the image side. At a time of image blur correction, the biconvex positive lens L12, the biconcave negative lens L13, and the biconcave negative lens L14 move in a direction perpendicular to an optical axis.

An aspheric surface is provided to a total of two surfaces, which are both surfaces of the biconvex positive lens L15.

An example 8 is an example of a zoom optical system. The zoom optical system includes in order from an object side, a first lens unit G1 having a positive refractive power, a second lens unit G2 having a negative refractive power, a third lens unit G3 having a positive refractive power, a fourth lens unit G4 having a negative refractive power, and a fifth lens unit G5 having a positive refractive power. An aperture stop (stop) S is disposed in the third lens unit G3.

The first lens unit G1 includes a biconvex positive lens L1, a negative meniscus lens L2 having a convex surface directed toward the object side, and a positive meniscus lens L3 having a convex surface directed toward the object side. Here, the negative meniscus lens L2 and the positive meniscus lens L3 are cemented.

The second lens unit G2 includes a biconcave negative lens L4, a positive meniscus lens L5 having a convex surface directed toward the object side, and a biconcave negative lens L6. Here, the biconcave negative lens L4 and the positive meniscus lens L5 are cemented.

The third lens unit G3 includes a biconvex positive lens L7, a biconvex positive lens L8, a biconcave negative lens L9, a negative meniscus lens L10 having a convex surface directed toward the object side, a biconvex positive lens L11, a biconvex positive lens L12, a biconcave negative lens L13, a biconcave negative lens L14, and a biconvex positive lens L15.

Here, the biconvex positive lens L8 and the biconcave negative lens L9 are cemented. The negative meniscus lens L10 and the biconvex positive lens L11 are cemented. The biconvex positive lens L12 and the biconcave negative lens L13 are cemented.

The fourth lens unit G4 includes a negative meniscus lens L16 having a convex surface directed toward the object side and a positive meniscus lens L17 having a convex surface directed toward the object side. Here, the negative meniscus lens L16 and the positive meniscus lens L17 are cemented.

The fifth lens unit G5 includes a biconcave negative lens L18, a biconvex positive lens L19, a positive meniscus lens L20 having a convex surface directed toward an image side, and a negative meniscus lens L21 having a convex surface directed toward the image side. Here, the positive meniscus lens L20 and the negative meniscus lens L21 are cemented.

At a time of zooming from a wide angle end to a telephoto end, the first lens unit G1, the third lens unit G3, and the fifth lens unit G5 are fixed. The second lens unit G2 moves toward the image side. The fourth lens unit G4, after moving toward the image side, moves toward the object side. The aperture stop S is fixed together with the third lens unit G3.

At a time of focusing from a far point to a near point, the fourth lens unit G4 moves toward the image side. At a time of image blur correction, the biconvex positive lens L12, the biconcave negative lens L13, and the biconcave negative lens L14 move in a direction perpendicular to an optical axis.

An aspheric surface is provided to a total of two surfaces, which are both surfaces of the biconvex positive lens L15.

An example 9 is an example of a zoom optical system. The zoom optical system includes in order from an object side, a first lens unit G1 having a positive refractive power, a second lens unit G2 having a negative refractive power, a third lens unit G3 having a positive refractive power, a fourth lens unit G4 having a negative refractive power, a fifth lens unit G5 having a negative refractive power, and a sixth lens unit G6 having a positive refractive power. An aperture stop (stop) S is disposed in the third lens unit G3.

The first lens unit G1 includes a biconvex positive lens L1, a negative meniscus lens L2 having a convex surface directed toward the object side, and a positive meniscus lens L3 having a convex surface directed toward the object side. Here, the negative meniscus lens L2 and the positive meniscus lens L3 are cemented.

The second lens unit G2 includes a biconcave negative lens L4, a positive meniscus lens L5 having a convex surface directed toward the object side, and a biconcave negative lens L6. Here, the biconcave negative lens L4 and the positive meniscus lens L5 are cemented.

The third lens unit G3 includes a biconvex positive lens L7, a biconvex positive lens L8, a biconcave negative lens L9, a negative meniscus lens L10 having a convex surface directed toward the object side, a biconvex positive lens L11, a positive meniscus lens L12 having a convex surface directed toward an image side, a biconcave negative lens L13, a biconcave negative lens L14, and a biconvex positive lens L15.

Here, the biconvex positive lens L8 and the biconcave negative lens L9 are cemented. The negative meniscus lens L10 and the biconvex positive lens L11 are cemented. The positive meniscus lens L12 and the biconcave negative lens L13 are cemented.

The fourth lens unit G4 includes a negative meniscus lens L16 having a convex surface directed toward the object side and a positive meniscus lens L17 having a convex surface directed toward the object side. Here, the negative meniscus lens L16 and the positive meniscus lens L17 are cemented.

The fifth lens unit G5 includes a biconcave negative lens L18.

The sixth lens unit G6 includes a biconvex positive lens L19, a positive meniscus lens L20 having a convex surface directed toward the image side, and a negative meniscus lens L21 having a convex surface directed toward the image side. Here, the positive meniscus lens L20 and the negative meniscus lens L21 are cemented.

At a time of zooming from a wide angle end to a telephoto end, the first lens unit G1, the third lens unit G3, and the sixth lens unit G6 are fixed. The second lens unit G2 moves toward the image side. The fourth lens unit G4, after moving toward the image side, moves toward the object side. The fifth lens unit G5 moves toward the object side. The aperture stop S is fixed together with the third lens unit G3.

At a time of focusing from a far point to a near point, the fourth lens unit G4 moves toward the image side. At a time of motion blur correction, the positive meniscus lens L12, the biconcave negative lens L13, and the biconcave negative lens L14 move in a direction perpendicular to an optical axis.

An aspheric surface is provided to a total of two surfaces, which are both surfaces of the biconvex positive lens L15.

Numerical data of each example described above is shown below. In Surface data, r denotes radius of curvature of each lens surface, d denotes a distance between respective lens surfaces, nd denotes a refractive index of each lens for a d-line, νd denotes an Abbe number for each lens and *denotes an aspherical surface.

Moreover, in various data and zoom data, OB denotes a distance up to an object, f denotes a focal length of the overall system, FNO denotes an F-number, ω denotes a half angle of view, BF denotes a back focus, and LTL denotes an overall length of the optical system. The back focus is expressed as a distance from a lens surface nearest to an image up to a paraxial image plane, subjected to air-conversion. The overall length is a length obtained by adding the back focus to a distance from a lens surface nearest to the object up to a lens surface nearest to the image. Infinity indicates when focused to an object at infinity, close distance indicates when focused to an object at a close distance, and extremely close distance indicates when focused to an object at an extremely close distance. Zoom data 1 is data when focused to an object at infinity and zoom data 2 is data when focused to an object at a close distance. The unit of OB is meters.

A shape of an aspherical surface is defined by the following expression where the direction of the optical axis is represented by z, the direction orthogonal to the optical axis is represented by y, a conical coefficient is represented by K, aspherical surface coefficients are represented by A4, A6, A8, A10, A12 . . . .

Z=(y²/r)/[1+{1−(1+k)(y/r)²}^{1/2}]+A4y⁴+A6y⁶+A8y⁸+A10y¹⁰+A12y¹²+ . . .

Further, in the aspherical surface coefficients, ‘e−n’ (where, n is an integral number) indicates ‘10⁻ⁿ’. Moreover, these symbols are commonly used in the following numerical data for each example.

### Example 1

Unit mm
Surface data

| Surface no. | r | d | nd | νd |
|---|---|---|---|---|
| Object plane | ∞ | ∞ | | |
| 1 | 204.387 | 3.95 | 1.91082 | 35.25 |
| 2 | −105.022 | 0.10 | | |
| 3 | 56.912 | 6.42 | 1.49700 | 81.54 |
| 4 | −62.187 | 1.20 | 1.75211 | 25.05 |
| 5 | 121.592 | 0.88 | | |
| 6 | 46.943 | 3.97 | 1.59282 | 68.63 |
| 7 | 235.707 | Variable | | |
| 8 | −116.457 | 1.50 | 1.48749 | 70.23 |
| 9 | 30.698 | 2.16 | | |
| 10 | 986.859 | 1.30 | 1.70154 | 41.24 |
| 11 | 17.857 | 4.36 | 1.80810 | 22.76 |
| 12 | 46.149 | Variable | | |
| 13 (Stop) | ∞ | 3.00 | | |
| 14 | 233.060 | 4.00 | 1.49700 | 81.54 |
| 15 | −38.666 | 0.20 | | |
| 16 | −920.251 | 5.00 | 1.69680 | 55.53 |
| 17 | −18.840 | 1.00 | 1.85026 | 32.27 |
| 18 | −257.093 | 1.00 | | |
| 19 | 97.406 | 3.00 | 1.89190 | 37.13 |
| 20 | −32.740 | 1.10 | 1.49700 | 81.54 |
| 21 | 37.978 | 3.22 | | |
| 22 | −33.706 | 1.00 | 1.72047 | 34.71 |
| 23 | 61.443 | 1.50 | | |
| 24* | 39.812 | 5.00 | 1.61881 | 63.85 |
| 25* | −28.735 | 0.02 | | |
| 26 | 30.221 | 2.15 | 1.49700 | 81.54 |
| 27 | 103.465 | Variable | | |
| 28* | −53.348 | 1.20 | 1.80625 | 40.91 |
| 29* | 17.906 | 0.56 | | |
| 30 | 22.248 | 2.30 | 1.92286 | 20.88 |
| 31 | 43.201 | Variable | | |
| 32 | 49.910 | 1.41 | 1.92286 | 20.88 |
| 33 | 34.664 | 0.10 | | |
| 34 | 35.754 | 5.00 | 1.88300 | 40.76 |
| 35 | −268.790 | Variable | | |
| Image | ∞ | | | |
| pickup | | | | |
| surface | | | | |

Aspherical surface data

24th surface
k = 0.000
A4 = −8.64270e−06, A6 = −1.31059e−08, A8 = 4.27256e−11
25th surface
k = 0.000
A4 = 1.72324e−06, A6 = −1.44263e−08, A8 = 2.17360e−11
28th surface
k = 0.000
A4 = 3.83571e−06, A6 = −1.04756e−08, A8 = −1.03076e−10
29th surface
k = 0.000
A4 = −1.32659e−05, A6 = −3.17333e−08, A8 = −2.59171e−10

Various data

| | | | extremely |
|---|---|---|---|
| | Infinity | close distance | Close distance |
| f | 91.10 | | |
| FNO. | 2.88 | | |
| 2ω | 13.67 | | |
| BF (in air) | 34.57 | 34.57 | 34.57 |
| LTL (in air) | 151.80 | 151.80 | 151.80 |
| Reproduction ratio | 0.00 | −0.50 | −1.00 |
| d7 | 2.50 | 8.55 | 20.00 |
| d12 | 23.48 | 17.43 | 5.98 |
| d27 | 3.96 | 12.09 | 19.03 |
| d31 | 19.67 | 11.54 | 4.61 |
| d35 | 34.57 | 34.57 | 34.57 |

Unit focal length

| | | | | |
|---|---|---|---|---|
| f1 = 46.47 | f2 = −31.05 | f3 = 32.16 | f4 = −24.98 | f5 = 50.74 |

### Example 2

Unit mm
Surface data

| Surface no. | r | d | nd | νd |
|---|---|---|---|---|
| Object plane | ∞ | ∞ | | |
| 1 | 123.794 | 4.07 | 1.91082 | 35.25 |
| 2 | −121.914 | 0.44 | | |
| 3 | 61.036 | 6.76 | 1.49700 | 81.54 |
| 4 | −64.287 | 1.20 | 1.84666 | 23.78 |
| 5 | 157.006 | 0.68 | | |
| 6 | 50.048 | 4.00 | 1.59282 | 68.63 |
| 7 | 271.012 | Variable | | |
| 8 | −112.998 | 1.50 | 1.48749 | 70.23 |
| 9 | 28.820 | 2.70 | | |
| 10 | −1102.237 | 1.30 | 1.70154 | 41.24 |
| 11 | 17.333 | 4.36 | 1.80810 | 22.76 |
| 12 | 47.310 | Variable | | |
| 13 (Stop) | ∞ | 3.00 | | |
| 14 | −408.579 | 4.00 | 1.49700 | 81.54 |
| 15 | −40.964 | 0.20 | | |
| 16 | 163.904 | 5.00 | 1.69680 | 55.53 |
| 17 | −24.105 | 1.00 | 2.00069 | 25.46 |
| 18 | −60.416 | 1.78 | | |
| 19 | −73.000 | 3.00 | 1.85478 | 24.80 |
| 20 | −46.321 | 1.10 | 1.58313 | 59.38 |
| 21* | 33.565 | 2.62 | | |
| 22 | 53.993 | 4.40 | 1.49700 | 81.54 |
| 23 | −36.522 | 0.15 | | |
| 24 | 29.173 | 3.60 | 1.49700 | 81.54 |
| 25 | 164.388 | Variable | | |
| 26* | −35.891 | 1.20 | 1.58313 | 59.38 |
| 27* | 21.812 | 0.20 | | |
| 28 | 18.393 | 2.30 | 1.92286 | 20.88 |
| 29 | 19.794 | Variable | | |
| 30 | 50.124 | 1.41 | 1.92286 | 20.88 |
| 31 | 34.251 | 0.12 | | |
| 32 | 35.448 | 5.00 | 1.88300 | 40.76 |
| 33 | −227.969 | Variable | | |
| Image | ∞ | | | |
| pickup | | | | |
| surface | | | | |

Aspherical surface data

21st surface
k = 0.000
A4 = −4.62409e−06, A6 = −6.23367e−09, A8 = 1.38024e−11
26th surface
k = 0.000
A4 = 1.94197e−05, A6 = −7.06991e−08, A8 = 3.85251e−10
27th surface
k = 0.000
A4 = 7.42645e−06, A6 = −5.88575e−08, A8 = 5.31721e−10

Various data

| | | | extremely |
|---|---|---|---|
| | Infinity | close distance | Close distance |
| f | 91.00 | | |
| FNO. | 2.88 | | |
| 2ω | 13.68 | | |
| BF (in air) | 33.84 | 33.84 | 33.84 |
| LTL (in air) | 150.45 | 150.45 | 150.45 |
| Reproduction ratio | 0.00 | −0.50 | −1.00 |
| d7 | 2.50 | 8.73 | 19.00 |
| d12 | 21.50 | 15.27 | 5.00 |
| d25 | 4.49 | 12.75 | 20.42 |
| d29 | 21.03 | 12.77 | 5.10 |
| d33 | 33.84 | 33.84 | 33.84 |

Unit focal length

| | | | | |
|---|---|---|---|---|
| f1 = 46.21 | f2 = −29.07 | f3 = 32.38 | f4 = −25.48 | f5 = 49.79 |

### Example 3

Unit mm
Surface data

| Surface no. | r | d | nd | νd |
|---|---|---|---|---|
| Object plane | ∞ | ∞ | | |
| 1 | 92.202 | 4.40 | 1.90043 | 37.37 |
| 2 | −137.608 | 0.10 | | |
| 3 | 47.227 | 6.86 | 1.49700 | 81.54 |
| 4 | −64.920 | 1.20 | 1.85478 | 24.80 |
| 5 | 96.985 | 1.10 | | |
| 6 | 42.802 | 4.11 | 1.55332 | 71.68 |
| 7 | 595.119 | Variable | | |
| 8 | 321.503 | 1.50 | 1.58313 | 59.38 |
| 9 | 25.135 | 3.54 | | |
| 10 | −68.430 | 1.30 | 1.75700 | 47.82 |
| 11 | 17.739 | 4.47 | 1.80810 | 22.76 |
| 12 | 66.380 | Variable | | |
| 13 (Stop) | ∞ | 3.00 | | |
| 14 | −50.000 | 1.30 | 1.72047 | 34.71 |
| 15 | 43.588 | 6.20 | 1.59282 | 68.63 |
| 16 | −38.287 | 0.20 | | |
| 17 | 77.666 | 3.44 | 1.90043 | 37.37 |
| 18 | −64.296 | 0.30 | | |
| 19 | −145.307 | 1.30 | 1.65412 | 39.68 |
| 20 | 42.604 | 2.50 | | |
| 21* | 41.193 | 4.80 | 1.77250 | 49.50 |
| 22 | −38.400 | 1.20 | 1.80810 | 22.76 |
| 23 | −113.009 | Variable | | |
| 24* | −88.752 | 1.20 | 1.80625 | 40.91 |
| 25* | 22.996 | 0.20 | | |
| 26 | 23.982 | 2.42 | 1.92286 | 20.88 |
| 27 | 44.778 | Variable | | |
| 28 | 35.264 | 1.60 | 1.92286 | 20.88 |
| 29 | 28.756 | 0.48 | | |
| 30 | 32.539 | 5.00 | 1.69680 | 55.53 |
| 31 | 736.567 | Variable | | |
| Image | ∞ | | | |
| pickup | | | | |
| surface | | | | |

Aspherical surface data

21st surface
k = 0.000
A4 = −1.71374e−06, A6 = 1.54876e−09, A8 = −4.63603e−12
24th surface
k = 0.000
A4 = 7.62471e−07, A6 = −2.37313e−08, A8 = 9.41326e−11
25th surface
k = 0.000
A4 = −2.49802e−06, A6 = −2.60367e−08, A8 = 9.73906e−11

Various data

| | | | extremely |
|---|---|---|---|
| | Infinity | close distance | Close distance |
| f | 91.03 | | |
| FNO. | 2.88 | | |
| 2ω | 13.68 | | |
| BF (in air) | 38.59 | 38.59 | 38.59 |
| LTL (in air) | 151.62 | 151.62 | 151.62 |
| Reproduction ratio | 0.00 | −0.50 | −1.00 |
| d7 | 2.50 | 6.93 | 14.51 |
| d12 | 17.01 | 12.58 | 5.00 |
| d23 | 3.70 | 14.81 | 24.68 |
| d27 | 26.09 | 14.97 | 5.10 |
| d31 | 38.59 | 38.59 | 38.59 |

Unit focal length

| | | | | |
|---|---|---|---|---|
| f1 = 41.20 | f2 = −22.55 | f3 = 32.33 | f4 = −37.94 | f5 = 67.14 |

### Example 4

Unit mm
Surface data

| Surface no. | r | d | nd | νd |
|---|---|---|---|---|
| Object plane | ∞ | ∞ | | |
| 1 | 155.290 | 3.81 | 1.95375 | 32.32 |
| 2 | −120.739 | 0.10 | | |
| 3 | 43.361 | 7.11 | 1.49700 | 81.54 |
| 4 | −65.018 | 1.20 | 1.75211 | 25.05 |
| 5 | 66.651 | 1.54 | | |
| 6 | 61.393 | 3.97 | 1.59282 | 68.63 |
| 7 | −317.732 | Variable | | |
| 8 | −108.692 | 1.50 | 1.48749 | 70.23 |
| 9 | 23.607 | 3.66 | | |
| 10 | −63.624 | 1.30 | 1.59551 | 39.24 |
| 11 | 21.616 | 4.36 | 1.80810 | 22.76 |
| 12 | 93.589 | Variable | | |
| 13 (Stop) | ∞ | 3.00 | | |
| 14* | 36.268 | 5.30 | 1.49700 | 81.54 |
| 15* | −42.798 | 1.78 | | |
| 16 | −30.167 | 1.10 | 1.69895 | 30.13 |
| 17 | 100.268 | 5.00 | 1.77250 | 49.60 |
| 18 | −27.011 | Variable | | |
| 19* | −89.461 | 1.00 | 1.80625 | 40.91 |
| 20* | 20.506 | 0.94 | | |
| 21 | 26.090 | 2.30 | 1.92286 | 20.88 |
| 22 | 54.967 | Variable | | |
| 23 | 43.552 | 1.41 | 1.92286 | 20.88 |
| 24 | 29.903 | 1.28 | | |
| 25 | 32.959 | 5.00 | 1.81600 | 46.62 |
| 26 | −1466.298 | Variable | | |
| Image | ∞ | | | |
| pickup | | | | |
| surface | | | | |

Aspherical surface data

14th surface
k = 0.000
A4 = 1.07545e−06, A6 = 7.44447e−09, A8 = 1.90947e−10
15th surface
k = 0.000
A4 = 2.06491e−05, A6 = 1.30939e−08, A8 = 2.35062e−10
19th surface
k = 0.000
A4 = −2.05396e−06, A6 = −6.51618e−09, A8 = 1.69175e−11
20th surface
k = 0.000
A4 = −1.24573e−05, A6 = −2.05328e−08, A8 = −1.85223e−11

Various data

| | | | extremely |
|---|---|---|---|
| | Infinity | close distance | Close distance |
| f | 91.02 | | |
| FNO. | 2.88 | | |
| 2ω | 13.59 | | |
| BF (in air) | 41.46 | 41.46 | 41.46 |
| LTL (in air) | 151.63 | 151.63 | 151.63 |
| Reproduction ratio | 0.00 | −0.50 | −1.00 |
| d7 | 2.50 | 6.97 | 15.35 |
| d12 | 20.35 | 15.88 | 7.50 |
| d18 | 3.40 | 13.89 | 23.55 |
| d22 | 27.25 | 16.76 | 7.10 |
| d26 | 41.46 | 41.46 | 41.46 |

Unit focal length

| | | | | |
|---|---|---|---|---|
| f1 = 45.99 | f2 = −28.86 | f3 = 33.42 | f4 = −34.21 | f5 = 62.49 |

### Example 5

Unit mm
Surface data

| Surface no. | r | d | nd | νd |
|---|---|---|---|---|
| Object plane | ∞ | ∞ | | |
| 1 | 133.168 | 11.81 | 1.48749 | 70.23 |
| 2 | −2359.129 | 0.20 | | |
| 3 | 116.357 | 3.80 | 1.83400 | 37.16 |
| 4 | 70.858 | 15.07 | 1.43875 | 94.66 |
| 5 | 899.129 | Variable | | |
| 6 | −1781.962 | 2.35 | 1.48749 | 70.23 |
| 7 | 46.329 | 5.97 | 1.85478 | 24.80 |
| 8 | 66.914 | 5.15 | | |
| 9 | −187.736 | 1.80 | 1.69680 | 55.53 |
| 10 | 151.953 | Variable | | |
| 11 | 54.375 | 7.87 | 1.70154 | 41.24 |
| 12 | −528.893 | 0.55 | | |
| 13 | 36.389 | 8.56 | 1.49700 | 81.54 |
| 14 | −187.152 | 1.80 | 1.88300 | 40.76 |
| 15 | 152.853 | 4.91 | | |
| 16 (Stop) | ∞ | 2.60 | | |
| 17 | 96.920 | 1.51 | 2.00100 | 29.13 |
| 18 | 23.355 | 7.03 | 1.49700 | 81.54 |
| 19 | 165.160 | 7.35 | | |
| 20 | −279.360 | 3.40 | 1.80100 | 34.97 |
| 21 | −35.122 | 1.00 | 1.69680 | 55.53 |
| 22 | 87.557 | 1.41 | | |
| 23 | −386.520 | 1.00 | 1.78800 | 47.37 |
| 24 | 70.056 | 3.50 | | |
| 25* | 25.776 | 6.84 | 1.61881 | 63.85 |
| 26* | −57.485 | Variable | | |
| 27 | 68.637 | 1.00 | 1.83481 | 42.73 |
| 28 | 16.711 | 2.10 | 1.80810 | 22.76 |
| 29 | 22.025 | Variable | | |
| 30 | −135.932 | 2.40 | 1.76182 | 26.52 |
| 31 | −16.289 | 1.00 | 1.88300 | 40.76 |
| 32 | 39.756 | Variable | | |
| 33 | 53.677 | 5.00 | 1.84666 | 23.78 |
| 34 | −31.220 | 0.20 | | |
| 35 | −65.245 | 4.50 | 1.80000 | 29.84 |
| 36 | −17.459 | 1.50 | 1.94595 | 17.98 |
| 37 | −109.637 | Variable | | |
| Image pickup surface | ∞ | | | |

Aspherical surface data

25th surface
k = 0.000
A4 = −1.09321e−05, A6 = −6.77521e−09, A8 = −9.79193e−12
26th surface
k = 0.000
A4 = 3.46924e−06, A6 = −6.11169e−09, A8 = 2.50249e−12

| | | |
|---|---|---|
| WE | ST | TE |

Zoom data 1

| | | | |
|---|---|---|---|
| f | 140.63 | 220.60 | 360.31 |
| FNO. | 4.21 | 4.21 | 4.21 |
| 2ω | 8.69 | 5.55 | 3.42 |
| BF (in air) | 25.79 | 25.79 | 25.79 |
| LTL (in air) | 255.63 | 255.63 | 255.63 |
| d5 | 4.27 | 37.72 | 69.09 |
| d10 | 66.32 | 32.87 | 1.50 |
| d26 | 13.96 | 12.73 | 3.00 |
| d29 | 14.81 | 14.99 | 23.00 |
| d32 | 7.29 | 8.34 | 10.06 |
| d37 | 25.79 | 25.79 | 25.79 |

Zoom data 2

| | | | |
|---|---|---|---|
| OB | 986.4 | 986.4 | 986.4 |
| d5 | 4.27 | 37.72 | 69.09 |
| d10 | 66.32 | 32.87 | 1.50 |
| d26 | 17.20 | 20.82 | 22.04 |
| d29 | 13.96 | 11.21 | 9.64 |
| d32 | 4.90 | 4.03 | 4.37 |
| d37 | 25.79 | 25.79 | 25.79 |

Unit focal length

| | | | |
|---|---|---|---|
| f1 = 196.30 | f2 = −76.04 | f3 = 60.35 | f4 = −39.34 |
| f5 = −28.06 | f6 = 33.13 | | |

### Example 6

Unit mm
Surface data

| Surface no. | r | d | nd | νd |
|---|---|---|---|---|
| Object plane | ∞ | ∞ | | |
| 1 | 152.378 | 11.16 | 1.43875 | 94.66 |
| 2 | −785.028 | 0.20 | | |
| 3 | 107.267 | 3.67 | 1.83400 | 37.16 |
| 4 | 72.391 | 14.20 | 1.43875 | 94.66 |
| 5 | 604.702 | Variable | | |
| 6 | −1338.874 | 2.20 | 1.49700 | 81.54 |
| 7 | 37.645 | 7.50 | 1.85478 | 24.80 |
| 8 | 49.297 | 4.93 | | |
| 9 | −120.261 | 1.80 | 1.72916 | 54.68 |
| 10 | 205.458 | Variable | | |
| 11 | 56.079 | 6.68 | 1.70154 | 41.24 |
| 12 | −596.574 | 2.18 | | |
| 13 | 32.396 | 6.80 | 1.49700 | 81.54 |
| 14 | 231.943 | 2.51 | | |
| 15 (Stop) | ∞ | 2.06 | | |
| 16 | −2717.224 | 3.43 | 2.00100 | 29.13 |
| 17 | 24.925 | 9.01 | 1.49700 | 81.54 |
| 18* | −130.226 | 4.00 | | |
| 19 | −149.974 | 3.60 | 1.80100 | 34.97 |
| 20 | −25.965 | 1.15 | 1.72916 | 54.68 |
| 21 | 286.035 | 1.00 | | |
| 22 | −162.449 | 1.15 | 1.78800 | 47.37 |
| 23 | 76.640 | 3.50 | | |
| 24* | 27.617 | 6.50 | 1.61881 | 63.85 |
| 25 | −51.577 | Variable | | |
| 26 | 116.518 | 1.00 | 1.69680 | 55.53 |
| 27 | 18.394 | 2.08 | 1.80810 | 22.76 |
| 28 | 23.229 | Variable | | |
| 29 | 329.309 | 2.00 | 1.72825 | 28.46 |
| 30 | −111.463 | 1.00 | 1.77250 | 49.60 |
| 31 | 38.131 | Variable | | |
| 32 | 67.421 | 4.50 | 1.80810 | 22.76 |
| 33 | −42.397 | 0.20 | | |
| 34 | −62.211 | 3.60 | 1.84666 | 23.78 |
| 35 | −24.445 | 1.50 | 1.94595 | 17.98 |
| 36 | −419.264 | Variable | | |
| Image pickup surface | ∞ | | | |

Aspherical surface data

18th surface
k = 0.000
A4 = −7.33808e−07, A6 = 8.57504e−09, A8 = −5.79950e−12
24th surface
k = 0.000
A4 = −1.36872e−05, A6 = 1.75165e−09, A8 = −7.90166e−12

| | | |
|---|---|---|
| WE | ST | TE |

Zoom data 1

| | | | |
|---|---|---|---|
| f | 102.59 | 201.19 | 394.31 |
| FNO. | 4.60 | 4.60 | 4.60 |
| 2ω | 11.93 | 6.08 | 3.11 |
| BF (in air) | 29.91 | 29.91 | 29.91 |
| LTL (in air) | 276.26 | 276.26 | 276.26 |
| d5 | 3.00 | 48.00 | 84.89 |
| d10 | 83.39 | 38.39 | 1.50 |
| d25 | 6.02 | 9.57 | 3.00 |
| d28 | 28.54 | 21.42 | 20.93 |
| d31 | 10.29 | 13.85 | 20.92 |
| d36 | 29.91 | 29.91 | 29.91 |

Zoom data 2

| | | | |
|---|---|---|---|
| OB | 963.1 | 963.1 | 963.1 |
| d5 | 3.00 | 48.00 | 84.89 |
| d10 | 83.39 | 38.39 | 1.50 |
| d25 | 6.90 | 13.47 | 19.96 |
| d28 | 31.12 | 27.39 | 21.40 |
| d31 | 6.83 | 3.99 | 3.49 |
| d36 | 29.91 | 29.91 | 29.91 |

Unit focal length

| | | | |
|---|---|---|---|
| f1 = 193.93 | f2 = −58.00 | f3 = 50.98 | f4 = −45.10 |
| f5 = −54.43 | f6 = 63.88 | | |

### Example 7

Unit mm
Surface data

| Surface no. | r | d | nd | νd |
|---|---|---|---|---|
| Object plane | ∞ | ∞ | | |
| 1 | 186.560 | 7.92 | 1.48749 | 70.23 |
| 2 | −2210.980 | 0.30 | | |
| 3 | 155.505 | 3.00 | 1.72047 | 34.71 |
| 4 | 92.440 | 11.80 | 1.43875 | 94.66 |
| 5 | 3662.903 | Variable | | |
| 6 | −1315.400 | 1.90 | 1.48749 | 70.23 |
| 7 | 45.851 | 6.50 | 1.84666 | 23.78 |
| 8 | 68.617 | 5.74 | | |
| 9 | −145.470 | 1.70 | 1.77250 | 49.60 |
| 10 | 184.725 | Variable | | |
| 11 | 89.508 | 6.66 | 1.74400 | 44.78 |
| 12 | −230.408 | 19.20 | | |
| 13 | 50.748 | 6.83 | 1.49700 | 81.54 |
| 14 | −96.508 | 2.00 | 1.88100 | 40.14 |
| 15 | 71.593 | 0.25 | | |
| 16 | 35.629 | 10.00 | 1.80810 | 22.76 |
| 17 | 23.150 | 6.50 | 1.43875 | 94.66 |
| 18 | 168.720 | 3.50 | | |
| 19 | 77.949 | 3.80 | 1.83481 | 42.73 |
| 20 | −74.361 | 0.90 | 1.53996 | 59.46 |
| 21 | 33.975 | 11.37 | | |
| 22 | −45.008 | 0.90 | 1.70154 | 41.24 |
| 23 | 446.846 | 3.00 | | |
| 24 (Stop) | ∞ | 1.00 | | |
| 25* | 28.561 | 9.24 | 1.58313 | 59.38 |
| 26* | −46.437 | Variable | | |
| 27 | 152.108 | 1.00 | 1.88300 | 40.76 |
| 28 | 28.638 | 2.00 | 1.85478 | 24.80 |
| 29 | 28.459 | Variable | | |
| 30 | −979.818 | 2.30 | 1.85478 | 24.80 |
| 31 | −28.039 | 1.00 | 1.71999 | 50.23 |
| 32 | 25.246 | Variable | | |
| 33 | 29.339 | 4.00 | 1.61340 | 44.27 |
| 34 | 131.851 | 28.09 | | |
| 35 | −7634.218 | 4.20 | 1.73800 | 32.26 |
| 36 | −22.311 | 1.32 | 1.80810 | 22.76 |
| 37 | −49.000 | Variable | | |
| Image pickup surface | ∞ | | | |

Aspherical surface data

25th surface
k = 0.000
A4 = −7.75790e−06, A6 = 5.19318e−11, A8 = −1.38826e−11,
A10 = 2.04906e−13
26th surface
k = 0.000
A4 = 6.79048e−06, A6 = −2.80188e−09, A8 = −8.54943e−13,
A10 = 2.19885e−13

| | | |
|---|---|---|
| WE | ST | TE |

Zoom data 1

| | | | |
|---|---|---|---|
| f | 152.71 | 239.55 | 391.26 |
| FNO. | 4.57 | 4.57 | 4.57 |
| 2ω | 8.08 | 5.14 | 3.15 |
| BF (in air) | 29.01 | 29.01 | 29.01 |
| LTL (in air) | 318.54 | 318.54 | 318.54 |
| d5 | 22.15 | 58.58 | 91.06 |
| d10 | 70.41 | 33.98 | 1.50 |
| d26 | 4.10 | 6.69 | 3.81 |
| d29 | 21.30 | 18.69 | 21.60 |
| d32 | 3.65 | 3.67 | 3.64 |
| d37 | 29.01 | 29.01 | 29.01 |

Zoom data 2

| | | | |
|---|---|---|---|
| OB | 979.3 | 979.3 | 979.3 |
| d5 | 22.15 | 58.58 | 91.06 |
| d10 | 70.41 | 33.98 | 1.50 |
| d26 | 7.08 | 14.05 | 21.92 |
| d29 | 18.80 | 12.05 | 4.74 |
| d32 | 3.18 | 2.96 | 2.39 |
| d37 | 29.01 | 29.01 | 29.01 |

Unit focal length

| | | | |
|---|---|---|---|
| f1 = 231.50 | f2 = −70.98 | f3 = 70.18 | f4 = −40.06 |
| f5 = −40.74 | f6 = 45.03 | | |

### Example 8

Unit mm
Surface data

| Surface no. | r | d | nd | νd |
|---|---|---|---|---|
| Object plane | ∞ | ∞ | | |
| 1 | 155.634 | 8.17 | 1.48749 | 70.23 |
| 2 | −1183.103 | 0.20 | | |
| 3 | 110.573 | 3.50 | 1.85026 | 32.27 |
| 4 | 73.279 | 11.00 | 1.43875 | 94.66 |
| 5 | 3782.461 | Variable | | |
| 6 | −361.104 | 2.20 | 1.48749 | 70.23 |
| 7 | 34.613 | 5.00 | 1.85478 | 24.80 |
| 8 | 52.833 | 4.19 | | |
| 9 | −116.440 | 1.80 | 1.72916 | 54.68 |
| 10 | 131.517 | Variable | | |
| 11 | 59.264 | 6.46 | 1.70154 | 41.24 |
| 12 | −193.249 | 3.94 | | |
| 13 | 33.975 | 6.89 | 1.49700 | 81.54 |
| 14 | −85.747 | 1.80 | 1.74320 | 49.34 |
| 15 | 49.717 | 3.66 | | |
| 16 (Stop) | ∞ | 3.88 | | |
| 17 | 31.834 | 3.14 | 2.00069 | 25.46 |
| 18 | 17.271 | 7.48 | 1.49700 | 81.54 |
| 19 | −128.719 | 4.00 | | |
| 20 | 1010.690 | 3.60 | 1.80100 | 34.97 |
| 21 | −25.882 | 1.15 | 1.71999 | 50.23 |
| 22 | 67.670 | 1.62 | | |
| 23 | −68.551 | 1.15 | 1.78800 | 47.37 |
| 24 | 73.576 | 3.50 | | |
| 25* | 26.386 | 5.50 | 1.61881 | 63.85 |
| 26* | −36.003 | Variable | | |
| 27 | 133.476 | 1.00 | 1.76200 | 40.10 |
| 28 | 15.237 | 2.10 | 1.80810 | 22.76 |
| 29 | 19.127 | Variable | | |
| 30 | −34.107 | 1.00 | 1.57135 | 52.95 |
| 31 | 59.395 | 3.00 | | |
| 32 | 60.447 | 5.00 | 1.84666 | 23.78 |
| 33 | −28.828 | 3.41 | | |
| 34 | −27.435 | 3.50 | 1.88300 | 40.76 |
| 35 | −17.930 | 1.50 | 1.94595 | 17.98 |
| 36 | −37.982 | Variable | | |
| Image pickup surface | ∞ | | | |

Aspherical surface data

25th surface
k = 0.000
A4 = −1.63131e−05, A6 = −6.45054e−09, A8 = −3.98622e−11
26th surface
k = 0.000
A4 = 7.67471e−07, A6 = −7.23041e−09, A8 = −4.38464e−11

| | | |
|---|---|---|
| WE | ST | TE |

Zoom data 1

| | | | |
|---|---|---|---|
| f | 71.50 | 120.02 | 235.01 |
| FNO. | 3.60 | 3.60 | 3.60 |
| 2ω | 17.29 | 10.20 | 5.20 |
| BF (in air) | 28.74 | 28.74 | 28.74 |
| LTL (in air) | 238.08 | 238.08 | 238.08 |
| d5 | 2.50 | 36.12 | 71.12 |
| d10 | 74.14 | 40.52 | 5.52 |
| d26 | 3.00 | 5.42 | 3.20 |
| d29 | 15.35 | 12.94 | 15.16 |
| d36 | 28.74 | 28.74 | 28.74 |

Zoom data 2

| | | | |
|---|---|---|---|
| OB | 961.9 | 961.9 | 961.9 |
| d5 | 2.50 | 36.12 | 71.12 |
| d10 | 74.14 | 40.52 | 5.52 |
| d26 | 4.06 | 8.43 | 13.78 |
| d29 | 14.29 | 9.93 | 4.58 |
| d36 | 28.74 | 28.74 | 28.74 |

Unit focal length

| | | | | |
|---|---|---|---|---|
| f1 = 179.04 | f2 = −54.19 | f3 = 48.18 | f4 = −30.34 | f5 = 89.39 |

### Example 9

Unit mm
Surface data

| Surface no. | r | d | nd | νd |
|---|---|---|---|---|
| Object plane | ∞ | ∞ | | |
| 1 | 152.370 | 7.98 | 1.48749 | 70.23 |
| 2 | −3200.585 | 0.20 | | |
| 3 | 109.237 | 3.50 | 1.85026 | 32.27 |
| 4 | 73.923 | 11.00 | 1.43875 | 94.66 |
| 5 | 2440.826 | Variable | | |
| 6 | −343.235 | 2.20 | 1.48749 | 70.23 |
| 7 | 34.053 | 5.00 | 1.85478 | 24.80 |
| 8 | 50.197 | 4.17 | | |
| 9 | −135.978 | 1.80 | 1.72916 | 54.68 |
| 10 | 120.167 | Variable | | |
| 11 | 57.322 | 6.23 | 1.70154 | 41.24 |
| 12 | −281.697 | 5.28 | | |
| 13 | 30.428 | 6.80 | 1.49700 | 81.54 |
| 14 | −115.293 | 1.80 | 1.74320 | 49.34 |
| 15 | 42.425 | 3.82 | | |
| 16 (Stop) | ∞ | 4.19 | | |
| 17 | 30.428 | 3.07 | 2.00069 | 25.46 |
| 18 | 17.196 | 7.24 | 1.49700 | 81.54 |
| 19 | −121.608 | 4.00 | | |
| 20 | −698.245 | 3.60 | 1.80100 | 34.97 |
| 21 | −24.872 | 1.15 | 1.71999 | 50.23 |
| 22 | 98.052 | 1.27 | | |
| 23 | −78.963 | 1.15 | 1.78800 | 47.37 |
| 24 | 51.771 | 3.50 | | |
| 25* | 23.183 | 5.50 | 1.61881 | 63.85 |
| 26* | −40.582 | Variable | | |
| 27 | 237.177 | 1.29 | 1.76200 | 40.10 |
| 28 | 14.212 | 2.10 | 1.80810 | 22.76 |
| 29 | 18.044 | Variable | | |
| 30 | −46.078 | 1.00 | 1.57135 | 52.95 |
| 31 | 66.330 | Variable | | |
| 32 | 69.793 | 5.00 | 1.84666 | 23.78 |
| 33 | −26.557 | 2.15 | | |
| 34 | −26.631 | 3.50 | 1.88300 | 40.76 |
| 35 | −17.866 | 1.50 | 1.94595 | 17.98 |
| 36 | −37.714 | Variable | | |
| Image pickup surface | ∞ | | | |

Aspherical surface data

25th surface
k = 0.000
A4 = −1.72280e−05, A6 = −2.24278e−08, A8 = −1.05495e−11
26th surface
k = 0.000
A4 = 2.82535e−06, A6 = −2.34671e−08, A8 = 1.76888e−11

| | | |
|---|---|---|
| WE | ST | TE |

Zoom data 1

| | | | |
|---|---|---|---|
| f | 67.01 | 120.04 | 250.00 |
| FNO. | 3.60 | 3.60 | 3.60 |
| 2ω | 18.37 | 10.17 | 4.89 |
| BF (in air) | 28.25 | 28.25 | 28.25 |
| LTL (in air) | 241.59 | 241.59 | 241.59 |
| d5 | 2.50 | 41.05 | 78.50 |
| d10 | 77.50 | 38.95 | 1.50 |
| d26 | 3.00 | 5.94 | 3.20 |
| d29 | 16.52 | 12.76 | 15.45 |
| d31 | 2.84 | 3.67 | 3.72 |
| d36 | 28.25 | 28.25 | 28.25 |

Zoom data 2

| | | | |
|---|---|---|---|
| OB | 1058.4 | 1058.4 | 1058.4 |
| d5 | 2.50 | 41.05 | 78.50 |
| d10 | 77.50 | 38.95 | 1.50 |
| d26 | 3.83 | 8.69 | 14.05 |
| d29 | 15.69 | 10.01 | 4.60 |
| d31 | 2.84 | 3.67 | 3.72 |
| d36 | 28.25 | 28.25 | 28.25 |

Unit focal length

| | | | |
|---|---|---|---|
| f1 = 182.58 | f2 = −53.09 | f3 = 48.08 | f4 = −26.39 |
| f5 = −47.43 | f6 = 31.20 | | |

Next, values of conditional expressions in each example are given below.

| | Example 1 | Example 2 | Example 3 |
|---|---|---|---|
| (1) \|fMF/fMB\| | 1.29 | 1.27 | 0.85 |
| (2) νdFFp | 81.54 | 81.54 | 81.54 |
| (3) LTL/fMF | 4.72 | 4.65 | 4.69 |
| (4) \|LTL/fFB\| | 4.89 | 5.18 | 6.72 |
| (5) fMB/fR | −0.49 | −0.51 | −0.57 |
| (6) \|fFF/fFB\| | 1.50 | 1.59 | 1.83 |
| (7) fFB/fMB | 1.24 | 1.14 | 0.59 |
| (8) fFF/fMF | 1.45 | 1.43 | 1.27 |
| (9) KISA | 1.30 | 1.40 | 1.62 |
| (10) KMBA | 3.90 | 3.66 | 2.92 |
| (11) νdRni | 20.88 | 20.88 | 20.88 |
| (12) LIS/LTL | 0.06 | 0.03 | 0.04 |
| | Example 4 | Example 5 | Example 6 |
| (1) \|fMF/fMB\| | 0.98 | 1.53 | 1.13 |
| (2) νdFFp | 81.54 | 94.66 | 94.66 |
| (3) LTL/fMF | 4.54 | 4.24 | 5.42 |
| (4) \|LTL/fFB\| | 5.25 | 3.36 | 4.76 |
| (5) fMB/fR | −0.55 | −1.19 | −0.71 |
| (6) \|fFF/fFB\| | 1.59 | 2.58 | 3.34 |
| (7) fFB/fMB | 0.84 | 1.93 | 1.29 |
| (8) fFF/fMF | 1.38 | 3.25 | 3.80 |
| (9) KISA | 2.01 | 1.77 | 1.94 |
| (10) KMBA | 3.35 | 5.98 | 6.67 |
| (11) νdRni | 20.88 | 17.98 | 17.98 |
| (12) LIS/LTL | 0.09 | 0.03 | 0.03 |
| | Example 7 | Example 8 | Example 9 |
| (1) \|fMF/fMB\| | 1.75 | 1.588 | 1.822 |
| (2) νdFFp | 94.66 | 94.66 | 94.66 |
| (3) LTL/fMF | 4.54 | 4.941 | 5.025 |
| (4) \|LTL/fFB\| | 4.49 | 4.394 | 4.55 |
| (5) fMB/fR | −0.89 | −0.339 | −0.846 |
| (6) \|fFF/fFB\| | 3.26 | 3.304 | 3.439 |
| (7) fFB/fMB | 1.77 | 1.786 | 2.012 |
| (8) fFF/fMF | 3.30 | 3.716 | 3.798 |
| (9) KISA | 1.73 | 1.794 | 1.8 |
| (10) KMBA | 6.96 | 4.6 | 4.6 |
| (11) νdRni | 22.76 | 17.98 | 17.98 |
| (12) LIS/LTL | 0.05 | 0.032 | 0.03 |

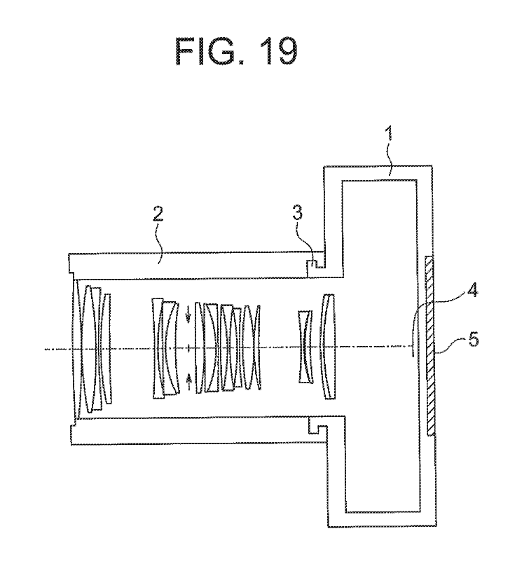

FIG. 19 is a cross-sectional view of a single-lens mirrorless camera as an electronic image pickup apparatus. In FIG. 19, a photographic optical system 2 is disposed inside a lens barrel of a single-lens mirrorless camera 1. A mount portion 3 enables the photographic optical system 2 to be detachable from a body of the single-lens mirrorless camera 1. As the mount portion 3, a mount such as a screw-type mount and a bayonet-type mount is to be used. In this example, a bayonet-type mount is used. Moreover, an image pickup element surface 4 and a back monitor 5 are disposed in the body of the single-lens mirrorless camera 1. As an image pickup element, an element such as a small-size CCD (charge coupled device) or a CMOS (complementary metal-oxide semiconductor) is to be used.

Moreover, as the photographic optical system 2 of the single-lens mirrorless camera 1, the macro lens or the zoom optical system described in example is to be used.

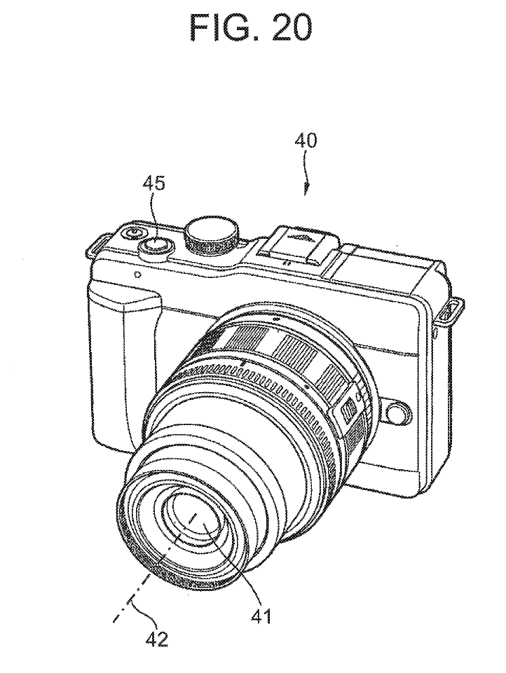

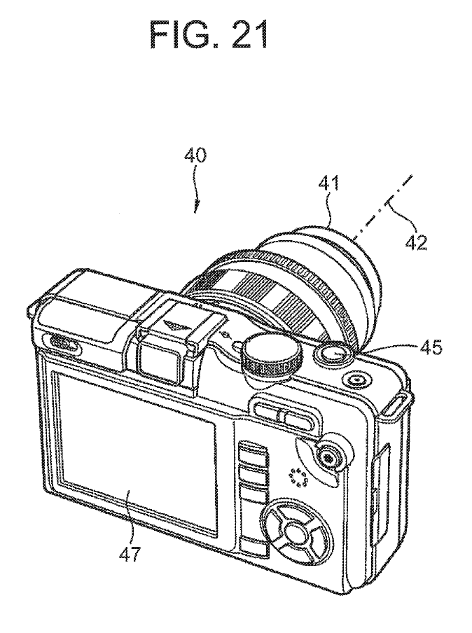

FIG. 20 and FIG. 21 are conceptual diagrams of an arrangement of the image pickup apparatus. FIG. 20 is a front perspective view of a digital camera 40 as the image pickup apparatus, and FIG. 21 is a rear perspective view of the digital camera 40. The macro lens or the zoom optical system according to the present example is used in a photographic optical system 41 of the digital camera 40.

The digital camera 40 according to the present embodiment includes the photographic optical system 41 which is positioned in a photographic optical path 42, a shutter button 45, and a liquid-crystal display monitor 47. As the shutter button 45 disposed on an upper portion of the digital camera 40 is pressed, in conjunction with the pressing of the shutter button 45, photography is carried out by the photographic optical system 41 such as the macro lens according to the first example. An object image which is formed by the photographic optical system 41 is formed on an image pickup element (photoelectric conversion surface) which is provided near an image forming surface. The object image which has been received optically by the image pickup element is displayed on the liquid-crystal display monitor 47 which is provided to a rear surface of the camera, as an electronic image by a processing means. Moreover, it is possible to record the electronic image which has been photographed, in a storage means.

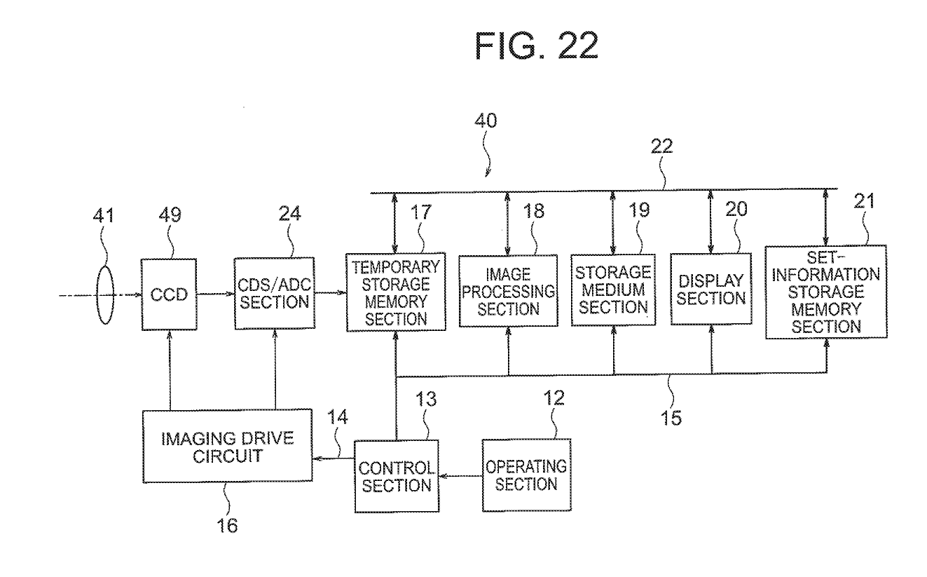

FIG. 22 is a structural block diagram of an internal circuit of main components of the digital camera 40. In the following description, the processing means described above includes for instance, a CDS/ADC section 24, a temporary storage memory 117, and an image processing section 18, and a storage means consists of a storage medium section 19 for example.

As shown in FIG. 22, the digital camera 40 includes an operating section 12, a control section 13 which is connected to the operating section 12, the temporary storage memory 17 and an imaging drive circuit 16 which are connected to a control-signal output port of the control section 13, via a bus 14 and a bus 15, the image processing section 18, the storage medium section 19, a display section 20, and a set-information storage memory section 21.

The temporary storage memory 17, the image processing section 18, the storage medium section 19, the display section 20, and the set-information storage memory section 21 are structured to be capable of mutually inputting and outputting data via a bus 22. Moreover, the CCD 49 and the CDS/ADC section 24 are connected to the imaging drive circuit 16.

The operating section 12 includes various input buttons and switches, and informs the control section 13 of event information which is input from outside (by a user of the digital camera) via these input buttons and switches. The control section 13 is a central processing unit (CPU), and has a built-in computer program memory which is not shown in the diagram. The control section 13 controls the entire digital camera 40 according to a computer program stored in this computer program memory.

The CCD 49 is driven and controlled by the imaging drive circuit 16, and which converts an amount of light for each pixel of the object image formed by the photographic optical system 41 to an electric signal, and outputs to the CDS/ADC section 24.

The CDS/ADC section 24 is a circuit which amplifies the electric signal which is input from the CCD 49, and carries out analog/digital conversion, and outputs to the temporary storage memory 17 image raw data (Bayer data, hereinafter called as ‘RAW data’) which is only amplified and converted to digital data.

The temporary storage memory 17 is a buffer which includes an SDRAM (Synchronous Dynamic Random Access Memory) for example, and is a memory device which stores temporarily the RAW data which is output from the CDS/ADC section 24. The image processing section 18 is a circuit which reads the RAW data stored in the temporary storage memory 17, or the RAW data stored in the storage medium section 19, and carries out electrically various image-processing including the distortion correction, based on image-quality parameters specified by the control section 13.

The storage medium section 19 is a recording medium in the form of a card or a stick including a flash memory for instance, detachably mounted. The storage medium section 19 records and maintains the RAW data transferred from the temporary storage memory 17 and image data subjected to image processing in the image processing section 18 in the card flash memory and the stick flash memory.

The display section 20 includes the liquid-crystal display monitor, and displays photographed RAW data, image data and operation menu on the liquid-crystal display monitor. The set-information storage memory section 21 includes a ROM section in which various image quality parameters are stored in advance, and a RAM section which stores image quality parameters which are selected by an input operation on the operating section 12, from among the image quality parameters which are read from the ROM section.

The present invention can have various modified examples without departing from the scope of the invention. Moreover, shapes of lenses and the number of lenses are not necessarily restricted to the shapes and the number of lenses indicated in the examples. In the examples described heretofore, the cover glass C may not be disposed necessarily. A lens that is not shown in the diagrams of the examples described above, and that does not have a refractive power practically may be disposed in a lens unit or outside the lens unit.

According to the present embodiment, it is possible to provide an image forming optical system which is superior in operability and mobility, and which has a high motion blur correction effect, and in which aberrations are corrected favorably, and an image pickup apparatus using the image forming optical system.

As described heretofore, the present invention is suitable for an image forming optical system which is superior in operability and mobility, and which has a high motion blur correction effect, and in which aberrations are corrected favorably, and an image pickup apparatus using the image forming optical system.

1. An image forming optical system comprising, in order from an object side:
a first lens unit having a positive refractive power;
a second lens unit having a negative refractive power;
a third lens unit having a positive refractive power;
a fourth lens unit having a negative refractive power; and
a rear-side lens unit which is disposed nearest to an image,
wherein:
at a time of focusing or at a time of zooming, a distance between the first lens unit and the second lens unit widens,
the rear-side lens unit includes a positive lens and a negative lens,
the first lens unit and the third lens unit, at all times, do not move in an optical axis direction,
at a time of focusing from an object at a long distance to an object at a close distance, the fourth lens unit moves toward an image side,
the third lens unit includes a positive lens and a negative lens,
a motion blur correction lens unit is disposed in the third lens unit,
a motion blur is corrected by the motion blur correction lens unit being moved in a direction perpendicular to an optical axis, and
the following conditional expressions (1) and (2) are satisfied:
0.59≤|fMF/fMB|≤3.0 (1),
70.0≤vdFFp (2),
where,
fMF denotes a focal length of the third lens unit,
fMB denotes a focal length of the fourth lens unit, and
vdFFp denotes Abbe's number which is the maximum among Abbe's numbers for positive lenses in the first lens unit.

2. An image forming optical system comprising, in order from an object side:
a first lens unit having a positive refractive power;
a second lens unit having a negative refractive power;
a third lens unit having a positive refractive power;
a fourth lens unit having a negative refractive power; and
a rear-side lens unit which is disposed nearest to an image,
wherein:
at a time of focusing or at a time of zooming, a distance between the first lens unit and the second lens unit widens,
the rear-side lens unit includes a positive lens and a negative lens,
the first lens unit and the third lens unit, at all times, do not move in an optical axis direction,
at a time of focusing from an object at a long distance to an object at a close distance, the fourth lens unit moves toward an image side,
the third lens unit includes a positive lens and a negative lens,
a motion blur correction lens unit is disposed in the third lens unit,
a motion blur is corrected by the motion blur correction lens unit being moved in a direction perpendicular to an optical axis, and
the following conditional expressions (2) and (3) are satisfied:
70.0≤vdFFp (2),
3.7≤LTL/fMF≤8.5 (3),
where,
fMF denotes a focal length of the third lens unit,
LTL denotes a distance from a lens surface nearest to object up to an image plane, and
vdFFp denotes Abbe's number which is the maximum among Abbe's numbers for positive lenses in the first lens unit.

3. An image forming optical system comprising, in order from an object side:
a first lens unit having a positive refractive power;
a second lens unit having a negative refractive power;
a third lens unit having a positive refractive power;
a fourth lens unit having a negative refractive power; and
a rear-side lens unit which is disposed nearest to an image,
wherein:
at a time of focusing or at a time of zooming, a distance between the first lens unit and the second lens unit widens,
the rear-side lens unit includes a positive lens and a negative lens,
the first lens unit and the third lens unit, at all times, do not move in an optical axis direction,
at a time of focusing from an object at a long distance to an object at a close distance, the fourth lens unit moves toward an image side,
the third lens unit includes a positive lens and a negative lens,
a motion blur correction lens unit is disposed in the third lens unit,
a motion blur is corrected by the motion blur correction lens unit being moved in a direction perpendicular to an optical axis,
the motion blur correction lens unit includes a positive lens and a negative lens, and
the following conditional expressions (4) and (5) are satisfied:
1.5≤|LTL/fFB|≤9.5 (4),
−2.5≤fMB/fR≤−0.15 (5),
where,
fFB denotes a focal length of the second lens unit,
LTL denotes a distance from a lens surface nearest to object up to an image plane,
fMB denotes a focal length of the fourth lens unit, and
fR denotes a focal length of the rear-side lens unit.

4. An image forming optical system comprising, in order from an object side:
a first lens unit having a positive refractive power;
a second lens unit having a negative refractive power;
a third lens unit having a positive refractive power;
a fourth lens unit having a negative refractive power; and
a rear-side lens unit which is disposed nearest to an image,
wherein:
at a time of focusing or at a time of zooming, a distance between the first lens unit and the second lens unit widens,
the rear-side lens unit includes a positive lens and a negative lens,
the first lens unit and the third lens unit, at all times, do not move in an optical axis direction,
at the time focusing from an object at a long distance to an object at a close distance, the fourth lens unit moves toward an image side,
the third lens unit includes a positive lens and a negative lens,
a motion blur correction lens unit is disposed in the third lens unit,
a motion blur is corrected by the motion blur correction lens unit being moved in a direction perpendicular to an optical axis,
the third lens unit includes in order from the object side, an object-side sub unit and an image-side sub unit,
the object-side sub unit includes a positive lens and a negative lens,
the image-side sub unit includes the motion blur correction lens unit, and
the motion blur correction lens unit includes a positive lens and a negative lens.

5. The image forming optical system according to claim 1, wherein the first lens unit, the third lens unit, and the rear-side lens unit, at all times, do not move in the optical axis direction.

6. The image forming optical system according to claim 1, wherein the motion blur correction lens unit includes a positive lens and a negative lens.

7. The image forming optical system according to claim 2, wherein the following conditional expression (1) is satisfied:
0.59≤|fMF/fMB|≤3.0 (1),
where,
fMF denotes a focal length of the third lens unit, and
fMB denotes a focal length of the fourth lens unit.

8. The image forming optical system according to claim 1, wherein the following conditional expression (3) is satisfied:
3.7≤LTL/fMF≤8.5 (3),
where,
fMF denotes a focal length of the third lens unit, and
LTL denotes a distance from a lens surface nearest to object up to an image plane.

9. The image forming optical system according to claim 1, wherein the following conditional expression (6) is satisfied:
0.8≤|fFF/fFB|≤5.0 (6),
where,
fFF denotes a focal length of the first lens unit, and
fFB denotes a focal length of the second lens unit.

10. The image forming optical system according to claim 1, wherein the following conditional expression (7) is satisfied:
0.45≤fFB/fMB≤3.0 (7),
where,
fFB denotes the focal length of the second lens unit, and
fMB denotes the focal length of the fourth lens unit.

11. The image forming optical system according to claim 1, wherein the following conditional expression (8) is satisfied:
0.8≤fFF/fMF≤5.0 (8),
where,
fFF denotes the focal length of the first lens unit, and
fMF denotes the focal length of the third lens unit.

12. The image forming optical system according to claim 1, wherein the following conditional expression (9) is satisfied:
0.7≤KISA≤3.5 (9),
where,
KISA=|MGISAback×(MGISA−1)|, and here
MGISAback denotes a lateral magnification of a first predetermined optical system at the time of focusing to an object at infinity, and
MGISA denotes a lateral magnification of the motion blur correction lens unit at the time of focusing to an object at infinity, and here
the first predetermined optical system is an optical system which includes all lenses positioned on an image side of the motion blur correction lens unit, and
the lateral magnification is a lateral magnification at a telephoto end in a case in which the image forming optical system is a zoom optical system.

13. The image forming optical system according to claim 1, wherein the following conditional expression (10) is satisfied:
2.5≤KMBA≤15 (10),
where,
KMBA=|MGMBAback²×(MGMBA²−1)|, and here
MGMBAback denotes a lateral magnification of a second predetermined optical system at the time of focusing to an object at infinity, and
MGMBA denotes a lateral magnification of the fourth lens unit at the time of focusing to an object at infinity, and here
the second predetermined optical system is an optical system which includes all lenses positioned on the image side of the fourth lens unit, and
the lateral magnification is a lateral magnification at a telephoto end in a case in which the image forming optical system is a zoom optical system.

14. The image forming optical system according to claim 1, wherein the following conditional expression (4) is satisfied:
1.5≤|LTL/fFB|≤9.5 (4),
where,
fFB denotes a focal length of the second lens unit, and
LTL denotes a distance from a lens surface nearest to object up to an image plane.

15. The image forming optical system according to claim 1, wherein the following conditional expression (5) is satisfied:
−2.5≤fMB/fR≤−0.15 (5),
where,
fMB denotes a focal length of the fourth lens unit, and
fR denotes a focal length of the rear-side lens unit.

16. The image forming optical system according to claim 1, wherein:
the first lens unit includes in order from the object side, a first sub unit having a positive refractive power and a second sub unit, and
the second sub unit includes two lenses for which signs of refractive power are different.

17. The image forming optical system according to claim 1, wherein:
the first lens unit includes in order from the object side, a first sub unit having a positive refractive power, a second sub unit, and a third sub unit having a positive refractive power, and
the second sub unit includes two lenses for which signs of refractive power are different.

18. The image forming optical system according to claim 1, wherein:
the third lens unit includes in order from an object side, an object-side sub unit and an image-side sub unit,
the object-side sub unit includes the positive lens and the negative lens, and
the image-side lens unit includes the motion blur correction lens unit.

19. (canceled)

20. The image forming optical system according to claim 4, wherein the motion blur correction lens unit has a positive refractive power.

21. The image forming optical system according to claim 1, wherein:
the motion blur correction lens unit has a positive refractive power, and
the entire third lens unit is the motion blur correction lens unit.

22. The image forming optical system according to claim 4, wherein:
the motion blur correction lens unit has a negative refractive power, and
the image-side sub unit includes the motion blur correction lens unit and a predetermined sub unit having a positive refractive power.

23. The image forming optical system according to claim 1, wherein:
the motion blur correction lens unit includes not less than two lenses, and
a positive lens and the negative lens are included in the lenses not less than two lenses.

24. The image forming optical system according to claim 1, wherein the motion blur correction lens unit includes at least two positive lenses and one negative lens.

25. The image forming optical system according to claim 1, wherein:
the fourth lens unit includes not less than two lenses, and
a positive lens and a negative lens are included in the lenses not less than two lenses.

26. The image forming optical system according to claim 1, wherein an aperture stop is disposed from the image side of the second lens unit up to the object side of the fourth lens unit.

27. (canceled)

28. The image forming optical system according to claim 1, wherein:
the rear-side lens unit includes one positive lens and one negative lens, and
one of the positive lens and the negative lens is positioned nearest to the image, and the other lens is disposed to be adjacent to the one of the positive lens and the negative lens.

29. (canceled)

30. The image forming optical system according to claim 1, wherein the following conditional expression (12) is satisfied:
0.015≤LIS/LTL≤0.2 (12),
where,
LIS denotes a total thickness on an optical axis of the motion blur correction lens unit, and
LTL denotes a distance from the lens surface nearest to object up to the image plane.

31. (canceled)

32. The image forming optical system according to claim 1, wherein:
the image forming optical system is a macro lens, and
the focusing is carried out by moving the second lens unit and the fourth lens unit toward the image side.

33. The image forming optical system according to claim 1, wherein:
the image forming optical system is a macro lens,
the macro lens includes in order from the object side, the first lens unit, the second lens unit, the third lens unit, the fourth lens unit, and the rear-side lens, and
the macro lens is a five-unit type optical system which includes no other lens unit and in which distances between lens units vary.

34. The image forming optical system according to claim 1, wherein:
the image forming optical system is a zoom lens of which an angle of view varies,
zooming toward a telephoto side is carried out at least by moving the second lens unit toward the image side and by moving the fourth lens unit, and
focusing to an object at a close distance is carried out by moving the fourth lens unit toward the image side.

35. (canceled)

36. (canceled)

37. An image pickup apparatus comprising:
an optical system; and
an image pickup element which has an image pickup surface, and which converts an image formed on the image pickup surface by the optical system to an electric signal, wherein the optical system is the image forming optical system according to claim 1.
